(19) United States
(12) Patent Application Publication
(10) Pub. No.: US 2016/0184154 A1
(43) Pub. Date: Jun. 30, 2016

(54) SUPPORT SURFACE SYSTEM

(71) Applicant: Stryker Corporation, Kalamazoo, MI (US)

(72) Inventors: Patrick Lafleche, Kalamazoo, MI (US); Manikantan Seshadrinathan, Portage, MI (US); Kent D. Pilchner, Holland, MI (US); James K. Galer, Byron Center, MI (US); Parikshit Atre, Kalamazoo, MI (US); Justin Raymond-Krochmal, Portage, MI (US); Bryan Garfoot, Portage, MI (US)

(21) Appl. No.: 14/984,450

(22) Filed: Dec. 30, 2015

Related U.S. Application Data
(60) Provisional application No. 62/098,562, filed on Dec. 31, 2014.

(51) Int. Cl. A61G 7/057; A61G 7/10; A47G 9/02

(52) U.S. Cl. CPC A61G 7/057; A47G 9/0238; A61G 7/1023; A61G 7/1038

(57) ABSTRACT

A cover system includes a base sheet, which is adapted to cover an underlying mattress, and a top sheet configured to wick away moisture and to cooperate with the base sheet to reduce shear on a patient supported on the cover system.

The present application claims the benefit of co-pending provisional application entitled SUPPORT SURFACE COVER, filed on Dec. 31, 2014, Ser. No. 62/098,562, which is incorporated by reference in its entirety herein.

### TECHNICAL FIELD AND BACKGROUND OF THE INVENTION

The present invention generally relates to a cover for a support surface, such as cushion or mattress, and more particularly to a cover that reduces the risk of a person, who is supported on the support surface, from developing pressure ulcers.

To reduce the chance of developing pressure ulcers, it is known to redistribute the pressure, either by adjusting the pressure in the underlying mattress or cushion, or by repositioning a person so that the pressure is redistributed to another portion of the patient's body. There are several other factors that may contribute to the development of pressure ulcers, including, for example, moisture and temperature. It is known that reducing moisture buildup and/or temperature buildup at the patient/support surface interface can also help reduce the risk of a pressure ulcer being formed.

Another factor that can also impact pressure ulcer forming is shear. People with weakened or fragile skin (due to age or health conditions, or due to pressure, heat, and/or moisture) tend to be more susceptible to injury from shear forces when being moved on a surface, for example, when being transferred or simply being repositioned.

The tendency when addressing these factors has been to add additional layers to the support surface, which while addressing moisture, heat and/or shear may compromise the performance of the underlying support surface.

Consequently, there is a need for a support surface cover that will reduce the risk of developing pressure ulcers but without impeding the performance of the underlying support surface.

### SUMMARY OF THE INVENTION

Accordingly, the present invention provides a support surface cover that is adapted to reduce moisture and temperature buildup at the interface between the person and the underlying support surface, and further which optionally reduces the shear at the patient/support surface interface.

In one form, a support surface cover includes a first panel and a carrier joined with the panel. The panel forms a first side for facing a person's body and a second side for facing a support surface, such as a cushion or a mattress. The panel comprises a moisture vapor permeable, liquid impermeable material, with the second side having a low friction surface to allow the panel to slide on the support surface. The support surface cover is adapted to engage or be engaged by the support surface when the support surface cover is placed over the support surface.

In one aspect, the carrier comprises a second panel surrounding the first panel.

In another aspect, the support surface cover further includes a second carrier, with the second carrier joined with the first panel.

In yet another aspect, the carrier includes pockets for engaging the support surface.

According to yet other aspects, the carrier comprises a stretchy material, such as a stretchy knit fabric, and optionally a polyester knit fabric. In this manner, the carrier allows the panel to move relative to the support surface.

The first panel may comprise a layer of moisture vapor permeable, liquid impermeable material, such as PTFE, and a knit or non-woven layer over and/or under the layer of the moisture vapor permeable, liquid impermeable material.

In other aspects, the first panel is removable from the carrier, with the panel being washable or disposable when removed from the carrier.

Optionally, the support surface cover may include one or more handles to allow a person to move a person supported on the cover. For example, the handles may be secured to the first panel.

In another form, a support surface cover includes a first panel having a first side and a second side, with the first side for facing a person's body, and the second side for facing a support surface. The second side includes a low friction surface to allow the panel to slide on the support surface. The support surface cover further includes a positioning system joined with the panel, which is adapted to engage the support surface when the support surface cover is placed over the support surface, and which has elastic properties wherein the positioning system allows the panel to slide relative to the support surface while still being engaged by the support surface.

For example, the positioning system may comprise a stretchy material, such as a stretchy knit fabric, which allows the first panel to move without the positioning system being disengaged from the support surface.

In one aspect, the first panel comprises a layer of moisture vapor permeable, liquid impermeable material, such as PTFE.

In another aspect, the first panel further comprises a knit layer, the knit layer forming the low friction surface. For example, the knit layer may comprise woven nylon or polyester knit.

In any of the above, the support surface cover further includes at least one handle to facilitate moving a person supported on the cover.

According to yet another form, the support surface cover includes a first panel having a first side and a second side, with the first side for facing a person's body, and the second side for facing a support surface. The second side includes a low friction surface. A carrier is joined with the first panel and is adapted to engage a support surface when the support surface cover is placed over the support surface. The carrier is formed from a different material than the first panel. The cover further includes at least one engagement structure, such as a handle, coupled with the first panel to assist in moving a person supported on the panel.

When the engagement structure is formed as a handle, the cover further includes reinforcement for the handle, for example, webbing, such as nylon webbing, which joins the handle to the first panel.

In another aspect, the reinforcement comprises a panel of webbing, with the webbing forming the handle, and optionally forming two or more handles.

In another aspect, the first panel comprises a layer of moisture vapor permeable, liquid impermeable material, such as PTFE. Optionally, the panel also includes a knit layer, with the knit layer forming the low friction surface.

In any of the above covers, the cover may also include a liquid collection space, formed for example, by at least one barrier adjacent the first panel, and optionally two spaced barriers on the first panel. For example, the barriers may comprise raised ridges along or adjacent the opposed longitudinal edges of the first panel.

In yet another form, a support surface cover includes a first panel and a carrier joined with the first panel, which is adapted to engage a support surface when the support surface cover is placed over the support surface, with the carrier formed from a different material than the first panel. The first panel is configured to form a liquid containment space on the first panel.

For example, the first panel includes two barriers spaced apart to thereby form the liquid containment space therebetween.

In any of the above, the first panel may comprise a layer of moisture vapor permeable, liquid impermeable material, such as PTFE. Further, the first panel may also comprise a knit layer to form a low friction surface.

In any of the above covers, the cover may form a flat or fitted bed sheet.

According to yet another embodiment, a bed sheet includes a base sheet comprising a stretchy material and which is configured to engage a mattress. A portion of the base sheet is moisture vapor permeable and liquid impermeable to provide breathability.

In one aspect, the base sheet is a stretchy material and optionally has a four-way stretch.

In other aspects, the base sheet comprises a first panel of material, and the portion of the base sheet that is moisture vapor permeable and liquid impermeable is a second panel of material joined with the first panel of material. The mattress facing side of the bed sheet optionally includes a low friction surface.

In a further aspect, the base sheet is formed from a stretchy material having sufficient stretch to allow the moisture vapor permeable and liquid impermeable portion to slide on the mattress without disengaging the base sheet from the mattress. For example, the portion further may include a non-woven or knit layer on an opposed side from the mattress facing side for facing a person's body.

In yet a further aspect, the base sheet includes pockets for engaging the mattress.

In the support surface cover or the bed sheet in any of the above, at least a portion of the cover or the bed sheet is disposable.

The support surface cover or the bed sheet in any of the above may be in combination with a cushion, a mattress, or a pad, including an absorbent pad.

According to yet another form, a method of supporting a person on a support surface includes providing a cover over the support surface, forming a person facing side with an upper side of the cover, forming a support surface facing side with a lower side of the cover, forming a low friction surface at the lower side of the cover, and forming a moisture vapor permeable, liquid impermeable portion at the person facing side. Optionally, the method further includes configuring the cover to secure to or be secured at the support surface.

In yet another embodiment, a support surface cover with an anchoring component includes a cover sheet having a top panel and a depending portion extending from the top panel. A body is mounted or formed at or in the depending portion, which is formed from a different material than the cover sheet and has an opening for receiving an anchor. The body includes a guide surface at or adjacent the opening for guiding the body onto the anchor.

For example, the body may be formed from plastic.

In another aspect, the opening includes converging sides for engaging the anchor, with the converging sides forming the guide surface.

In yet another aspect, the opening comprises a first portion and a second portion, with the first portion being larger than the second portion. The first portion is configured to receive the anchor there through. The second portion is sized to capture the anchor therein when the anchor is moved from the first portion into the second portion. For example, the first portion may form the guide surface.

In a further aspect, the cover further includes a tether coupled to the body for guiding the body over the anchor.

In one embodiment, the body is formed from flexible material. Further, the flexible material may comprise a stretchy material. In a further aspect, the cover may include a tether coupled to the body for stretching and guiding the body over the anchor.

According to another embodiment, a support surface cover with an anchoring component includes a cover sheet having a top panel and a depending portion extending from the top panel. A body is mounted or formed at or in the depending portion and includes an opening for receiving an anchor. The cover further includes a tether coupled to the body to facilitate positioning of the body relative to the anchor.

For example, the body may be formed from a flexible material, including a stretchy material.

In one aspect, the tether comprises a loop of material.

In yet another embodiment, a support surface cover and anchoring system includes a cover sheet having a top panel and a depending portion extending from the top panel. A first coupler is mounted at or to the depending portion. The system further includes a second coupler for mounting to a surface. The first coupler is adapted to releasably couple to the second coupler, with the first coupler or the second coupler adapted to guide the couplers into engagement with each other.

In one aspect, the first coupler or the second coupler comprises a magnet. In addition, the other of the first coupler and the second coupler may comprise a magnet.

In another aspect, the first coupler is mounted on an inward facing side of the depending portion.

According to yet another embodiment, a support surface cover includes a cover sheet having a top panel and a depending portion extending from the top panel. The cover further includes a body mounted or formed at or in the depending portion, with the body forming a hand hold.

In one embodiment, the body is molded with the depending portion.

In one aspect, the body has an opening.

Optionally, the body includes an engagement structure for engaging an anchor. For example, the engagement structure may comprise a projection extending from the body for engaging the anchor.

In another aspect, the cover is provided in combination with an anchor, with the anchor adapted to attach to a surface over which the cover overlays.

In one embodiment, the depending portion comprises a side extending from the top panel.

The top panel has a length and a width, with the side extending along the length. The body comprises an elongated strip of material extending along a portion of the side.

In one aspect, the elongated strip of material extends along the full length of the side.

For example, the body may comprise a plurality of elongated strips of material extending along at least a portion of the side.

In another embodiment, a support system includes a cushion with a side wall and a cover sheet having a top panel and a depending portion extending from the top panel. The depending portion has a height less than the height of the side wall. A first coupler is formed on or mounted at or to the depending portion. The cover system further includes a second coupler for mounting to the side wall. The first coupler is adapted to releasably couple to the second coupler, with the first coupler or the second coupler adapted to guide the couplers into engagement with each other.

In one aspect, the depending portion comprises a side extending from the top panel. The top panel has a length and width, with the side extending along the length.

In one embodiment, at least one of the couplers comprises a magnet.

In another embodiment, at least one of the couplers includes at least one projecting guide structure for guiding the couplers into engagement with each other. For example, the projecting guide structure may further mechanically couple the couplers together.

According to yet another embodiment, a support surface cover includes a first panel having a first side and a second side. The first side is for facing a person's body, and the second side is for facing a support surface. The cover further includes a positioning system joined with the first panel, which is adapted to engage the support surface when the support surface cover is placed over the support surface. The positioning system has a guide surface to allow one handed attachment of the first panel to the support surface.

In one embodiment, the positioning system includes a grommet. The grommet has non-circular interface the forms the guide surface.

In one aspect, the positioning system includes an elastic panel joined with the first panel. The elastic panel has an opening for receiving an anchor mounted to the support surface.

In addition, the support surface cover may further include a tether, such as a loop of fabric, coupled to the elastic panel to facilitate positioning of the opening over the anchor.

According to yet another embodiment, a cover system includes a base sheet, which is adapted to cover an underlying support surface, such as a mattress, and a top sheet that is configured to wick away moisture and, further, configured to cooperate with the base sheet to reduce shear on a patient supported on the cover system.

In one aspect, at least a portion of the top surface of the base sheet include a low friction region, and at least a portion of the bottom surface of the top sheet includes a low friction region, which at least generally aligns with the low friction region of the base sheet to reduce the friction between the top sheet and the base sheet.

In one aspect, the base sheet comprises a liquid impermeable, moisture permeable sheet. For example, the sheet may be formed from a weaved polyester or weaved nylon.

In a further aspect, the sheet includes a highly breathable urethane membrane laminate or an EPTFE membrane laminate.

In one embodiment, the top surface of the base sheet includes one or more regions of increased friction over the low friction region to limit undesirable movement. For example, the top surface of the base sheet may include one or more regions of increased friction for aligning with the head end of the underlying mattress. In this manner, the increased friction will limit the migration of a patient's pillow toward the head end of the mattress.

In another embodiment, the top surface of the base sheet may include one or more regions of increased friction for aligning with the opposed outer edges of the mattress to limit undesirable movement, such as migration of a patient off the side of the mattress.

In another embodiment, the top surface of the base sheet may include a region of increased friction at a medial portion of the base sheet, and further, which is oriented to extend transversely across the underlying mattress to limit the migration of a patient toward the foot end of the underlying mattress.

In a further aspect, the bottom surface of the top sheet includes a region of increased friction over the low friction region of the top sheet. For example, the region of increased friction of the top sheet and may be located in a thigh section of the top sheet.

In yet a further aspect, the top sheet includes a central portion for aligning over the mattress and two downwardly depending portions that extend from the central portion for extending along the sides of the mattress. Optionally, the downwardly depending portions include one or more handles, for example in the form of straps. Further, when provided in the form of straps, one or more of the straps may be angled with respect to the longitudinal axis of the top sheet and, therefore, extend toward the foot-end or head-end of the underlying mattress to facilitate moving/gliding a patient toward the foot end or head end of the mattress.

In one aspect, the one or more handles have high friction surfaces for facing the base sheet.

The top sheet also has a low friction underlying fabric that interface with the top surface of the base sheet that also has in its central part a low friction fabric, thereby creating a layer that is friction less and centrally located in on the support surface, limiting shear at the sacrum and coccyx as an example but also helping with repositioning the patient on the surface by gliding the top sheet on the bottom sheet, when the increase area of friction have been disengaged.

Both the top sheet and bottom sheet when use in combination are highly breathable thereby allowing for moisture management of the skin.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTIONS OF THE DRAWINGS

FIG. 1 is an exploded perspective view of a cover;

FIG. 1A is an enlarged view of detail 1A of FIG. 1;

FIG. 2 is a top perspective view of the cover of FIG. 1;

FIG. 2A is an enlarged cross-section view of detail 2A of FIG. 2;

FIG. 3 is a bottom perspective view of the cover of FIG. 2;

FIG. 4 is an exploded perspective view of another embodiment of the cover;

FIG. 5 is an enlarged detail view of sections V of FIG. 4;

FIG. 6 is a top perspective view of the cover of FIG. 4;

FIG. 7 is a bottom perspective view of the cover of FIG. 4;

FIG. 8 is an exploded perspective view of another embodiment of the cover;

FIG. 9 is an exploded perspective view of another embodiment of the cover;

FIG. 10 an exploded perspective view yet another embodiment of the cover;

FIG. 10A is an enlarged cross-section view of detail X of FIG. 2;

FIG. 11 is a fragmentary perspective view of a cover incorporating an anchoring system;

FIG. 11A is an elevation view of the portion of the cover shown in FIG. 11;

FIG. 11B is an exploded perspective view of the portion of the cover shown in FIG. 11;

FIG. 12 is a perspective view of an anchor of the anchoring system;

FIG. 13 is a partial fragmentary view of another embodiment of the anchoring system;

FIG. 14 is a partial fragmentary view of a third embodiment of an anchoring system;

FIG. 15 is a fourth embodiment of the anchoring system;

FIG. 15A is an elevation view of the anchoring system of FIG. 15;

FIG. 15B is a rear perspective view of the anchoring system of FIG. 15;

FIG. 15C is a side view of the anchoring system of FIG. 15;

FIG. 15D is an exploded perspective view of the anchoring system of FIG. 15;

FIG. 16 is an elevation view of another embodiment of the anchoring system of FIG. 15;

FIG. 17 is an exploded perspective view of the anchoring system of FIG. 16;

FIG. 18 is a partial fragmentary perspective view of a fifth embodiment of an anchoring system for a cover;

FIG. 19 is a similar view of FIG. 18 illustrating the cover being positioned to engage an anchor mounted to the underlying surface beneath the cover;

FIG. 20 is a similar view to FIGS. 18 and 19 illustrating the cover now anchored in place;

FIG. 20A is a perspective view of yet another embodiment of a cover adapted to anchor to a corner of a patient support surface, such as a mattress;

FIG. 21 is a partial fragmentary perspective view of a sixth embodiment of the anchoring system;

FIG. 22 is a perspective view of seventh embodiment of the anchoring system;

FIG. 22A is an exploded perspective view of the anchoring system of FIG. 22;

FIG. 22B is an exploded perspective view of another embodiment of the anchoring system of FIG. 22;

FIG. 23 is a perspective view of patient support with a cover incorporating an anchoring system as well as handles;

FIG. 24 is a perspective view of one embodiment of a handle for a patient support cover;

FIG. 24A is an exploded perspective view of the handle of FIG. 24;

FIG. 25 is a second embodiment of a handle for a patient support cover;

FIG. 25A is an exploded perspective view of the handle of FIG. 25;

FIG. 25B is another exploded perspective view of the handle of FIG. 25;

FIG. 26 is a third embodiment of a handle for a patient support cover;

FIG. 27 is a perspective view of another embodiment of a handle for a patient support cover;

FIG. 28 is an exploded perspective view of the handle of FIG. 27;

FIG. 29A is a perspective view of another embodiment of an anchoring system component for a patient support cover;

FIG. 29B is a rear perspective view of the anchoring system component of FIG. 29A;

FIG. 30A is a perspective view of another embodiment of an anchoring system component for a patient support cover; and

FIG. 30B is a rear perspective view of the anchoring system component of FIG. 30A

FIG. 31A is a perspective view of another embodiment of an anchoring system component for a patient support cover;

FIG. 31B is a rear perspective view of the anchoring system component of FIG. 31A;

FIG. 32 is an exploded perspective view of another embodiment of a cover suitable for use on a patient support surface, such as a mattress;

FIG. 33 is a cross-section view of the cover of FIG. 32;

FIG. 34 is in it is a perspective view of yet another embodiment of a cover;

FIG. 35 is a cross-section view of the cover and top surface of the patient support surface of FIG. 34;

FIG. 36 is a perspective view of yet another embodiment of a cover suitable for use on a patient support surface, such as a mattress;

FIG. 37 is a schematic drawing of another embodiment of a cover suitable for use on a patient support surface, such as a mattress;

FIG. 38 is a schematic drawing of a surface applied to or formed in the cover of FIG. 37;

FIG. 39 is a another schematic drawing of the cover of FIG. 37;

FIG. 40 is a perspective view of another embodiment of a cover assembly suitable for use on a patient support surface, such as a mattress;

FIG. 41 is a top plan view of another embodiment of a cover suitable for use on a patient support surface, such as a mattress;

FIG. 42 is an enlarged view of the strap of the cover of FIG. 41;

FIG. 43 is a bottom plan view of another embodiment of a cover suitable for use on a patient support surface, such as a mattress;

FIG. 44 is a perspective view of a cover system for use on a patient support surface such as the mattress;

FIG. 45 is a partial exploded perspective view of the cover system of FIG. 44; and

FIG. 46 is an exploded perspective view of the cover system of FIG. 44.

### DETAIL DESCRIPTION OF PREFERRED EMBODIMENTS

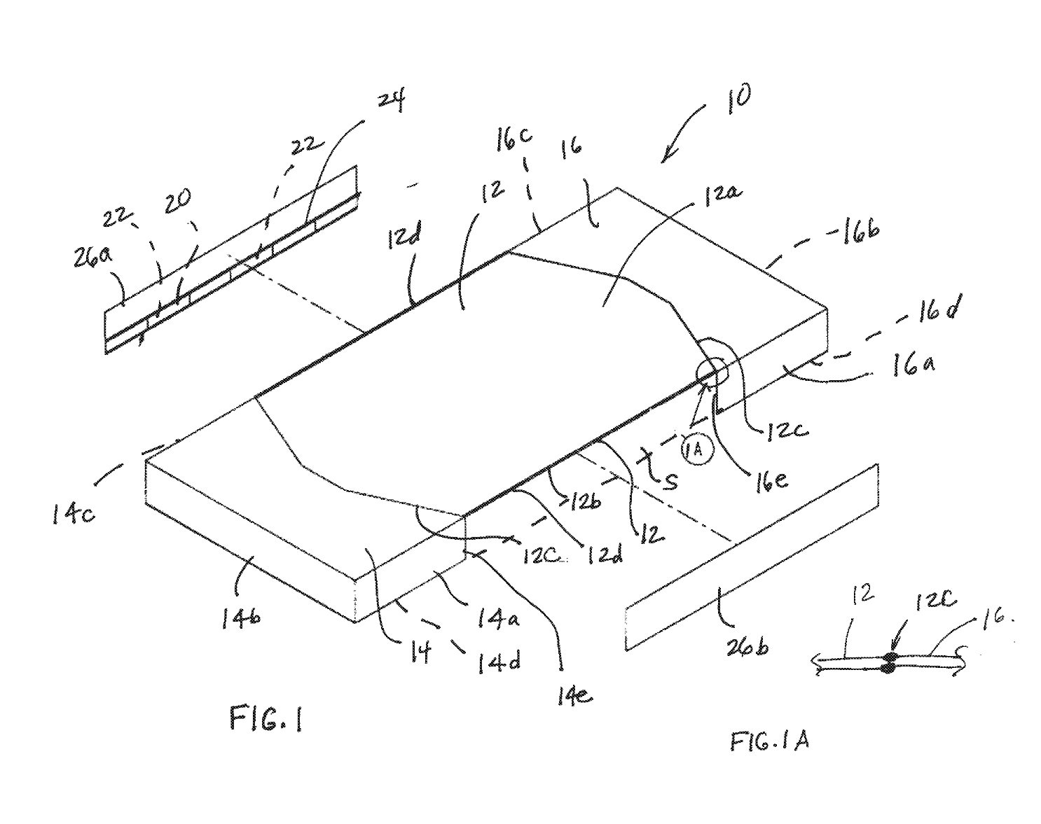

Referring to FIG. 1, the number 10 generally designates a cover for a support surface, such as a cushion, a mattress, or a pad, for example, on a bed, a stretcher, a cot, a wheelchair, or an operating room table. As will be more fully described below, cover 10 is adapted to engage or be engaged by the support surface and to improve the interface between a person and the support surface in a manner to reduce the risk of developing pressure ulcers, but without interfering with the performance of the underlying support surface. For example, as will be more fully described below, cover 10 may be configured to improve the micromanagement at the person/support surface interface, for example, to reduce moisture and/or temperature, and optionally reduce the shear between the person supported by cover 10 and the underlying support surface. Further, cover 10 may include one or more engagement structures to facilitate the movement, e.g. turning, of a person supported on the cover and the support surface, which can also reduce the likelihood of the person developing pressure ulcer.

Referring again to FIG. 1, cover 10 includes a first panel 12 configured for positioning under a person that is supported on an underlying surface S. As noted above, support surface S may comprise a cushion, a mattress, or a pad. The shape of the panel may vary, but in the illustrated embodiment, panel 12 has parallel longitudinal edges 12d and truncated triangular-shaped lateral edges 12c, which increase the central region of the panel where a person would be typically positioned and reduce length of the opposed outer edges of the panel to facilitate handling, as will be more fully described below.

Panel 12 is joined with one or more carriers 14 and 16, which are configured to secure panel 12 to surface S, and further to allow panel 12 to move without cover 10 disengaging from the support surface. For example, carriers 14 and 16 may have downwardly depending sides 14a, 14b, and 14c and 16a, 16b, and 16c, respectively, which are sized so that they may be tucked under surface S. Alternately, referring to FIG. 3, downwardly depending sides 14a, 14b, and 14c may be joined by a transverse panel 14d to form a pocket, which can be elasticized, for example at its edge, to extend under surface S to secure carrier 14 to the underlying surface. Similarly, carrier 16 may include a transverse panel 16d that is joined to and extends between sides 16a, 16b, and 16c to also form a pocket on the opposed end of the cover, and similarly may be elasticized to facilitate placement.

In the illustrated embodiment, carriers 14 and 16 are formed from panels and, optionally, formed from panels with elastic properties. Suitable materials for forming panels 14 and 16 include stretchy material, such as stretchy knit fabric, and, further, optionally polyester knit fabric. To reduce the shear between the patient and the underlying support surface S, panel 12 may include a low friction surface at its surface facing side 12b. In this manner, when a patient is moved relative to the support surface S, panel 12 will move with the patient due to its low friction surface. Panel 12's movement, however, is not then impeded by panels 14 and/or 16 due to the stretchability of panels 14 and 16. For example, panels 14 and 16 may have a two-way stretch or a four-way stretch. Thus, while panels 14 and 16 form a carrier for panel 12 they do not restrict movement of panel 12 across the upper surface of the support surface S.

To further facilitate the handling of a person supported on cover 10, cover 10 optionally includes one or more engagement structures 20 on one or more sides of the cover. For example, in the illustrated embodiment, engagement structures 20 comprise handles 22. Handles 22 may be formed by a strap 24, which is then secured, for example, by stitching at spaced intervals to thereby form loops there between and thereby form the handles. Strap 24 may be secured to the longitudinal edges 12d of panel 12 or mounted to a side panel 26a, which is then secured to the longitudinal edges 12d of panel 12. Side panel 26a may then be secured to the opposed free edges of downwardly depending sides 14a, 14c, 16a, and 16c of panels 14 and 16, respectively. For example, straps 24 and/or side panel 26a may be secured to panel 12 and panels 14 and 16 by stitching, welding, or the like, depending on the material forming the respective panels. Alternately, straps 24 or side panel 26a may be removably mounted, for example, by hook and loop fasteners (VELCRO).

The opposed side panel 26b may similarly include a strap to form handles. Alternately, side panel 26b may just simply comprise a panel that joins the longitudinal edge 12b of panel 12 and the opposed terminal edges 14e and 16e of downwardly depending sides 14a and 16a of panels 14 and 16, respectively.

As noted above, panels 12, 14, and 16 may be joined by welding, stitching, or the like, for example, along seams 12c, which may extend transversely across cover 10 in a linear fashion or as noted may be configured so that the central portion of panel 12 has a greater dimension than at its opposed longitudinal edges 12b. Referring to FIG. 1A, seams 12c may be formed at the abutting edges of the respective panels, as shown on FIG. 1A, to form a flat seam or may be formed by overlapping edges of the respective panels, which are then sewn or otherwise secured together, for example, by welding.

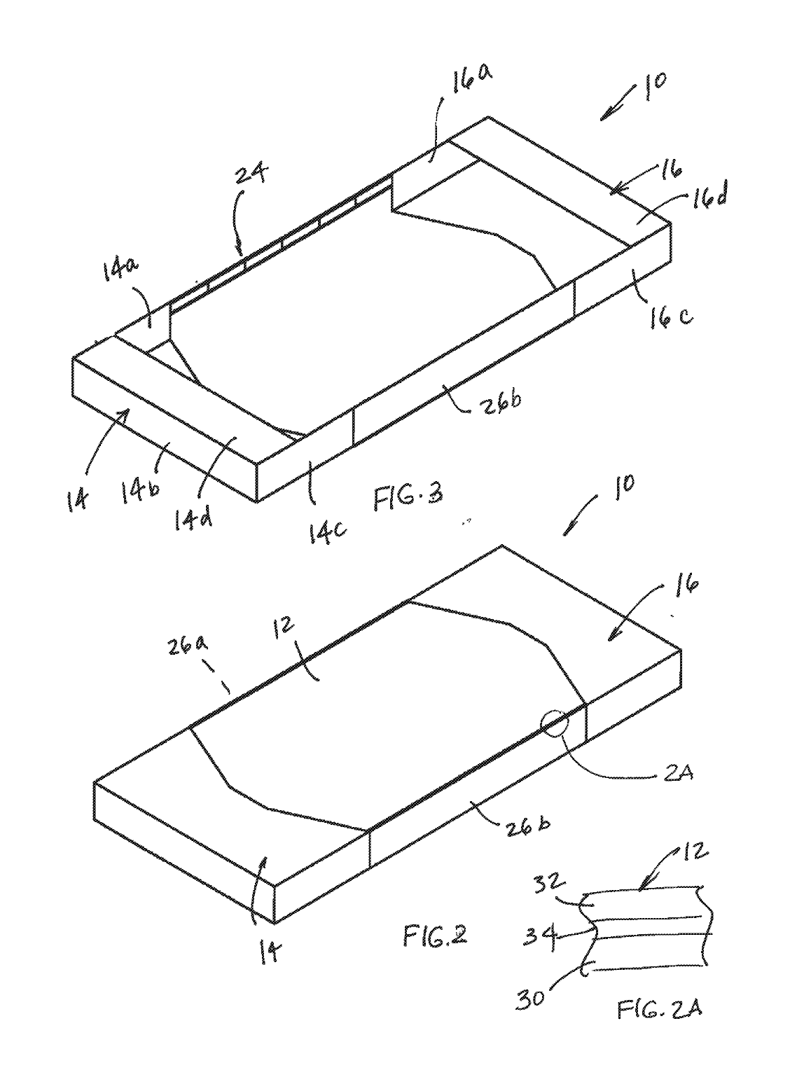

The thickness of the respective panels may be same. Alternately, the thickness of panels 14 and 16 may be generally equal, while the thickness of panel 12 may be greater than the thickness of either panel 14 or panel 16. To form the low friction surface, panel 12 may include a layer 30 (FIG. 2A) of woven nylon material at its support surface facing side 12b, which forms the low friction surface. In addition, layer 12 may include an upper layer 32 (FIB. 2A), which is configured to wick moisture away from the patient, and optionally further provide a surface, which is relatively easy to clean for example, by wiping down. For example, upper layer 32 may comprise a breathable fabric, such as GORTEX. Additionally, panel 12 further includes an intermediate layer 34 (FIG. 2A), for example, formed from a vapor permeable membrane, such as PTFE, which allows for air flow but is generally liquid impermeable to protect the support surface below from liquid intrusion. In this manner, in addition to reducing the shear between a patient and the underlying support surface S, panel 12 may also provide a layer that wicks moisture away from the patient, but while still allowing air flow through the panel.

Consequently, the cover may be formed from panels formed from different materials to provide different characteristics. As noted above, one of the panels may be formed from an elastic material to allow it to stretch and to allow the other panel, which is formed with a low friction surface to slide relative to the underlying support surface.

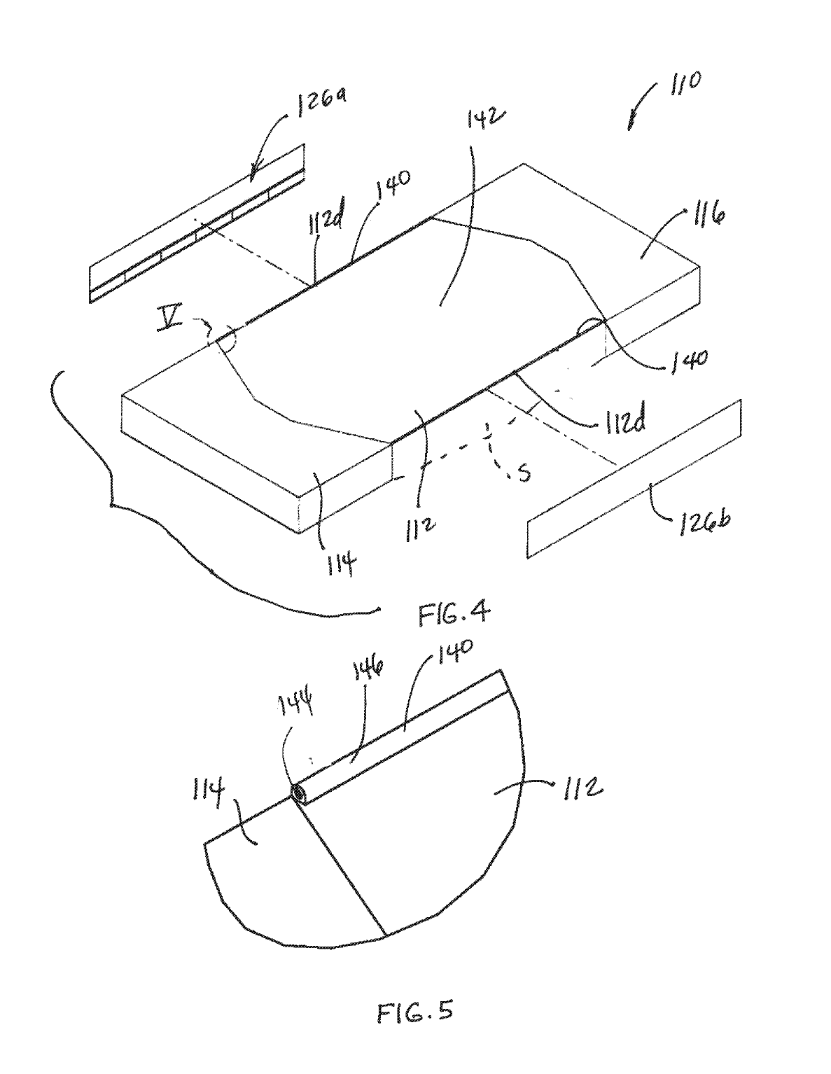

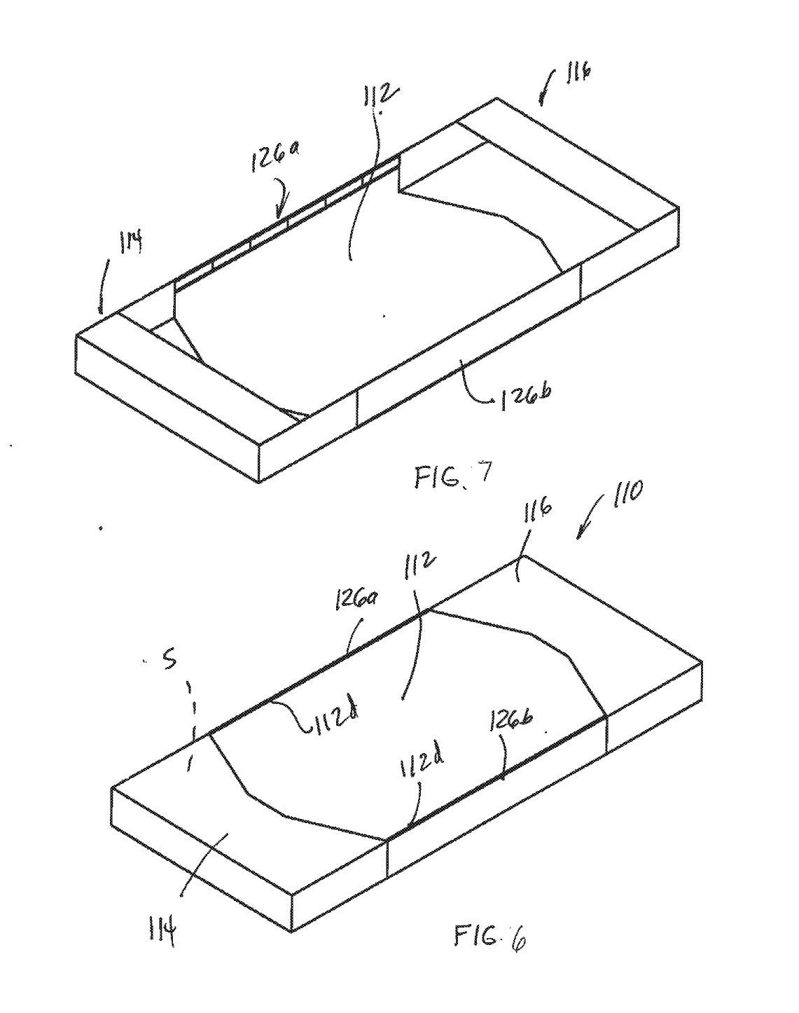

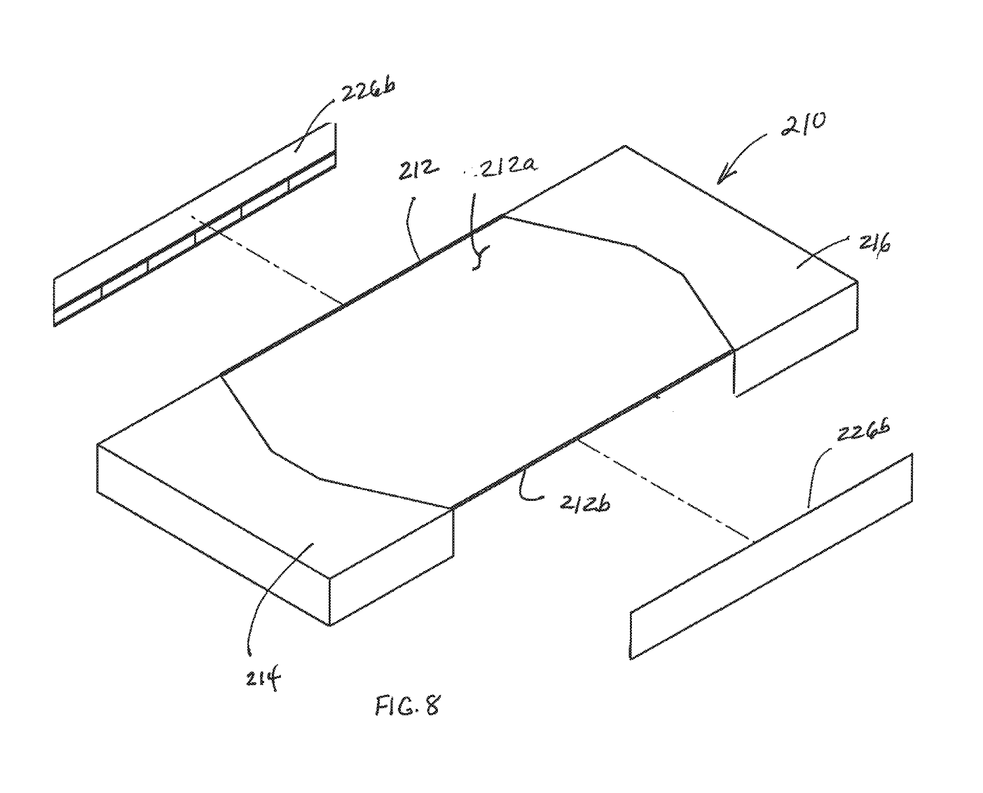

Referring to FIGS. 4-7, the number 110 generally designates another embodiment of the cover. Cover 110 similarly includes a first panel 112 and one or more carriers 114 and 116, which secure panel 112 to an underlying support surface S. Optionally, cover 110 includes two side panels 126a and 126b that extend between the respective carriers and, optionally, form a mounting surface for engagement structures, such as handles, so that a caregiver may move panel 112 relative to support surface S to thereby move a person who is supported on support surface S. For optional details of panel 112, carriers 114, 116, and side panels 126a and 126b, reference is made to the first embodiment with like numerals designating like parts.

In the illustrated embodiment, panel 112 is optionally configured to form a liquid containment space 142. For example, liquid containment space 142 may be formed between a pair of opposing barriers 140, which are provided on panel 112. For example, barriers 140 may be located at or adjacent the opposing longitudinal edges 112d of panel 112.

As best seen in FIG. 5, a suitable barrier 140 may be formed by a cord 144 enveloped in a sleeve 146 of material. Sleeve 146 may be either formed by an extension of panel 112 or may be a separate piece of material that is secured to panel 112, for example, by stitching, welding or the like. Barriers 140 may extend the full length of panel 112 or may extend over only a portion of the length of panel 112. Further, barriers 140 may be located at the connection between side panels 126a and 126b and panel 112 or may be formed inward of the longitudinal edges 112d of panel 112.

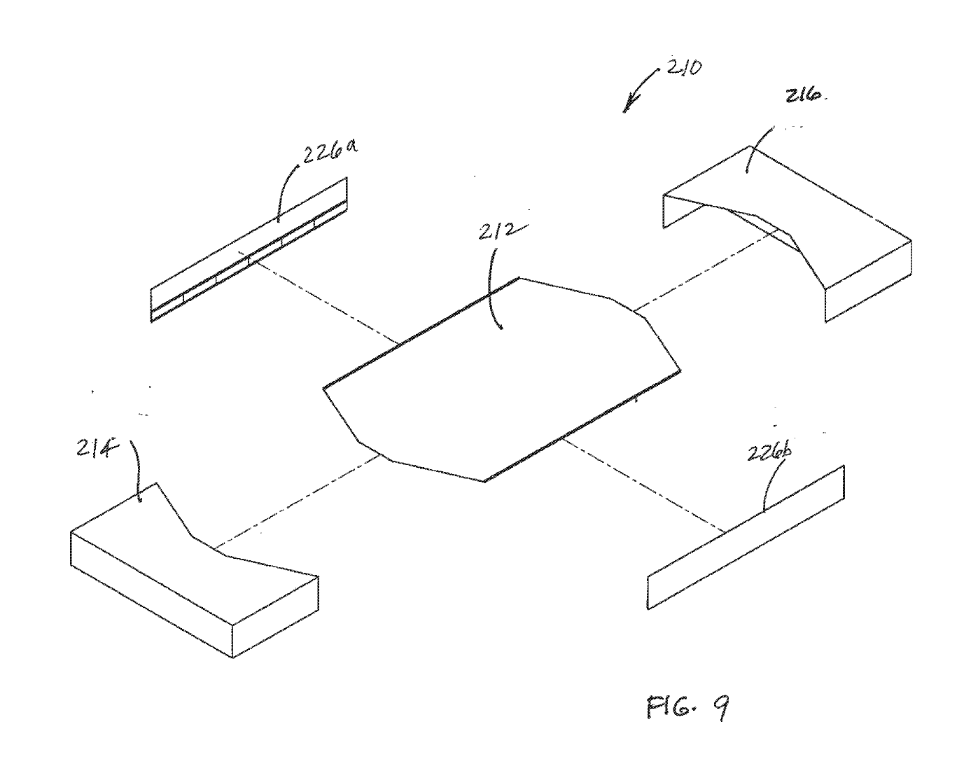

Referring to FIGS. 8 and 9, the numeral 210 generally designates another embodiment of a cover. Cover 210 similarly includes a panel 212, and one or more carriers 214 and 216. Further, cover 210 optionally includes side panels 226a and 226b. For details of panel 212, carriers 214 and 216, and side panels 226a and 226b reference is made to the previous embodiments. In the illustrated embodiment, as best seen in FIG. 9, panel 212 is removable from carriers 214 and 216 and side panels 226a and 226b so that it can be removed for washing or replacement. Further, side panels 226a and 226b may be removable from carriers 214 and 216. For example, each portion of cover 210 may be joined with the other portions or parts of the cover by way of hook and loop fasteners (e.g. Velcro strips) or other releasable fasteners to facilitate use, cleaning, and substitution. In this manner, each portion of cover 210 may be removed for cleaning or replacement. Further, each portion of cover 210 may be disposable.

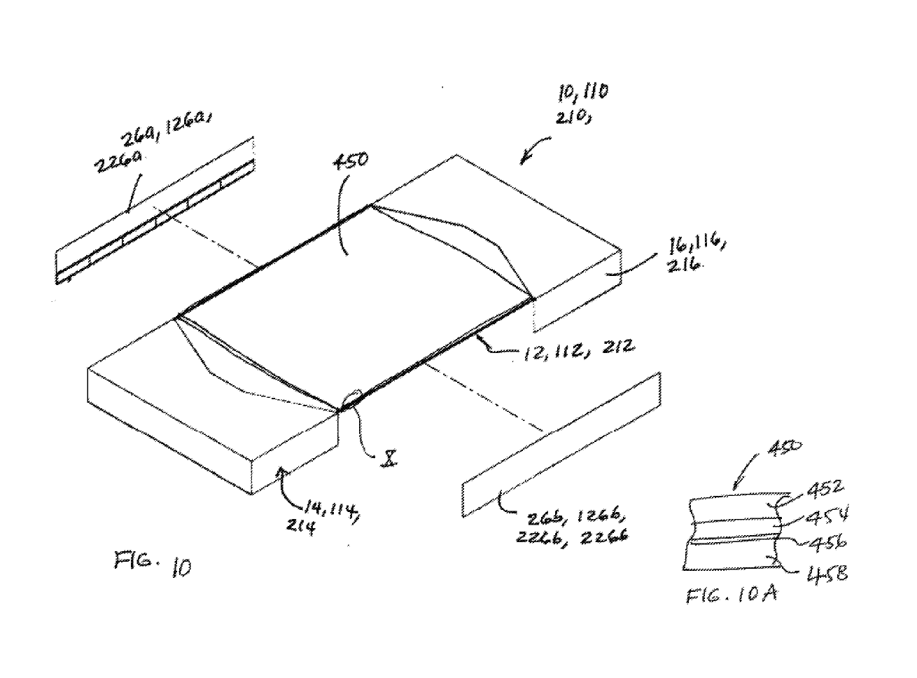

Referring to FIG. 10, any one of the above covers 10, 110, or 210 may also include a pad 450, for example, an absorbent pad. Pad 450 may be integrated into the cover, for example, by fasteners, including releasable fasteners, or it may be simply placed on the cover. Pad 450 is also configured to wick moisture away from a person lying on the respective cover. Pad 450 may also be configured to reduce shear forces on a patient and, further, adapted to facilitate moving, such as turning, a person.

Referring to FIG. 10A, pad 450 may be formed from multiple layers of material, similar to panels 12, 112, and 212. As best seen in FIG. 10A, pad 450 includes an upper layer 452, which faces the person and, as noted above, wicks moisture away from the interface with the person supported on pad 450 and the cover (10, 110, 210). For example, upper layer 452 may comprise a moisture vapor permeable, but liquid impermeable material, such as GORTEX or other engineered materials that allow moisture to pass through, but substantially block liquids from passing through. Below upper layer 452 is an intermediate layer 454, which absorbs the moisture, wicked away from the person. For example, layer 454 may comprise non-woven absorbent fibers or absorbent polymers, such as super absorbent polymers (SAP).

Positioned below absorbent layer 454 is a vapor permeable, but liquid impermeable layer 456, such as a PTFE membrane. This layer, therefore, can protect the underlying support surface from liquid intrusion, as well as or in place of the liquid impermeable layer of any of the panels 12, 112, or 212.

As noted above, pad 450 may also have a low friction lower surface. To that end, pad 450 has a lower layer formed from, for example, a nylon, which forms the low friction surface and also protects the PTFE membrane. To facilitate movement of a patient supported on pad 450, pad 450 may also incorporate handles, similar to handles 22 noted above, which are formed from straps or webbing that are secured to pad 450 at, for example, its opposed longitudinal edges.

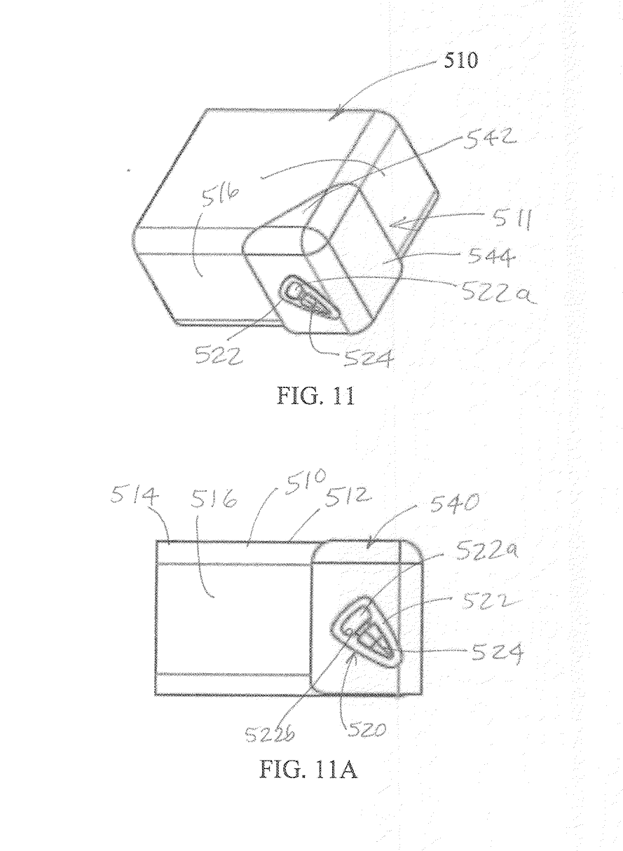

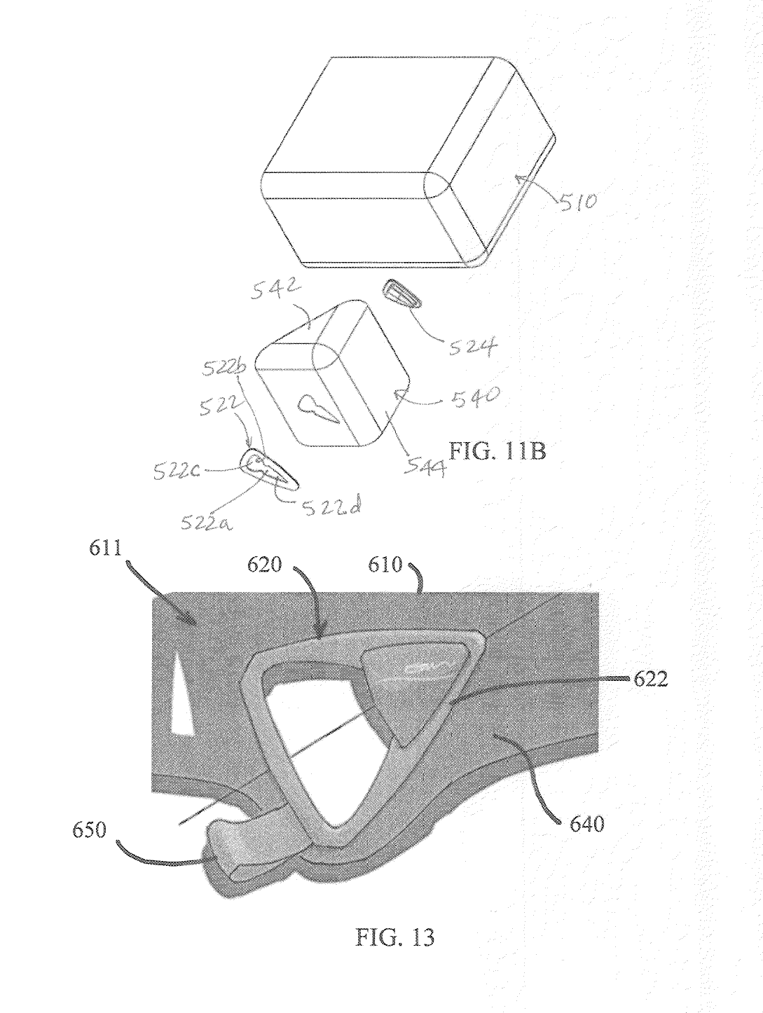

Referring to FIGS. 11, 11A, and 11B, the numeral 510 generally designates another embodiment of a cover that is suitable for covering at least the top surface of an underlying support, such as a patient support S, including a mattress. As will be more fully described below, cover 510 includes an anchoring system 511 that allows a caregiver to easily attach or detach the cover to one side of the patient support while standing on the other side of the patient support, without having to reach underneath the patient support. Further, anchoring system 511 may be configured to allow for a one-handed attachment and, further, a blind one-handed attachment of cover 510 to the underlying support.

In one embodiment, cover 510 includes a cover sheet 512 that forms a top panel 514 and a depending portion 516, which extends from top panel 514. For example, a suitable material for cover sheet 512 includes the materials described above in reference to the earlier embodiments. To facilitate anchoring cover sheet 512 to the underlying support, cover 510 includes one or more anchoring components 520 along a side or at a corner of cover sheet 512.

In the illustrated embodiment, anchoring component 520 is located at a corner and includes a body 522 formed or mounted at or in depending portion 516. For example, body 522 may be formed from a polymer, such as plastic, including TPU, TPE, Santoprene, or an elastomeric material. Body 522 includes an opening 522a for receiving an anchor 524, which is mounted to the underlining patient support beneath cover 510. Where body 522 overlays the depending portion, then the depending portion includes an opening to provide access to the anchor. For example, anchor 524 may be glued, stitched, welded (such as ultrasonic welding or heat staking) or molded to the underlying support. In addition, body 522 includes a guide surface 522b for guiding body 522 onto anchor 524. In the illustrated embodiment, opening 522a is generally triangular in shape with a first portion, such as an enlarged upper portion 522c, and a second, smaller portion, such as a tapered lower portion 522d, with the sides or edges of the first portion converging to form guide surface 522b to guide the anchor 524 when opening 522 is located over anchor 524.

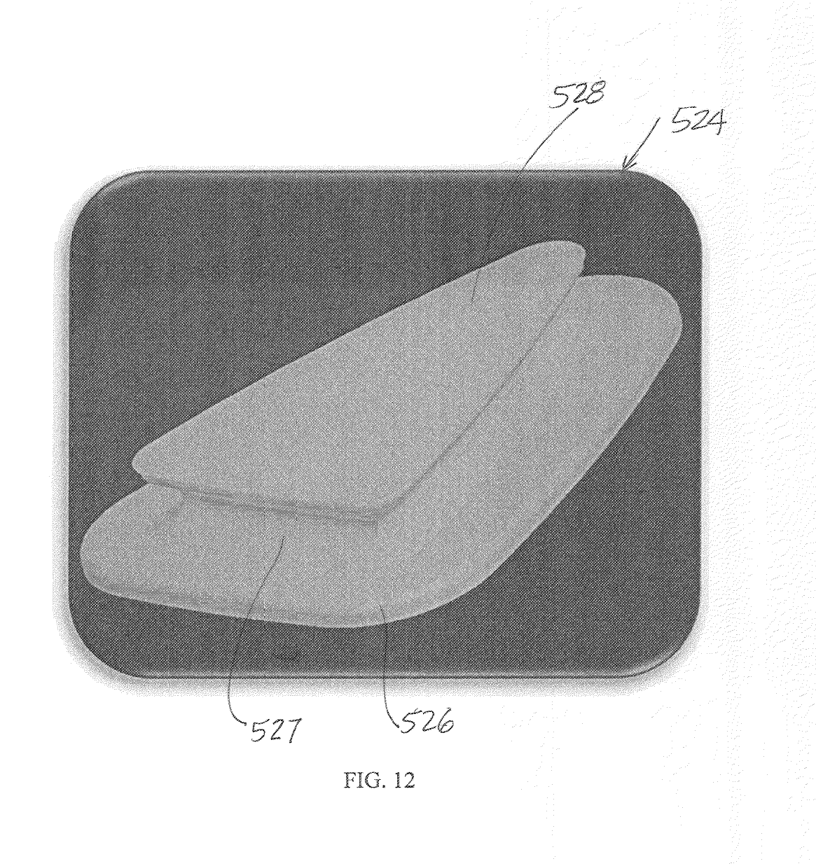

Referring to FIG. 12, anchor 524 includes a base 526 that is adapted to be mounted to the underlying support and a projecting body 528. Body 528 includes an enlarged flange 530, such as a triangular-shaped flange, which forms an overhang to form a perimeter lip. Flange 530 is larger than tapered lower portion 522d of opening 524, but smaller than the enlarged upper portion 522c to allow anchor 524 to be received in upper portion 522c of opening 522, but then when moved in lower portion 522d, captured in body 522. Thus, when anchor 524 is moved into lower portion 522d, the lip of flange 528 will trap anchor 524 in body 522, for example by friction. Optionally, opening 522 may include a narrowed portion to form a snap fit or friction coupling between the anchor and body 522, for example, between the transition between the larger upper portion and smaller lower portion of opening.

Referring again to FIG. 11B, anchoring system 511 may be supported in a corner cap 540. Corner cap 540 may be made from a polymer, such as plastic, and formed with a top side 542, which is secured to top panel 514, and two vertical sides 544, which either overlap downwardly depending portion 516 of cover 510 (or abut and join separate downwardly depending portions 516 of cover 510 to form part of the downwardly depending portion). For example, corner cap 540 may be joined with cover 510 by stitching, gluing, welding (such as ultrasonic welding or heat staking) or molding. Body 522 may be formed from a similar material to corner cap 540 or maybe formed from a different material and molded with corner cap 540 using, for example, a two-shot molding process.

In this manner, when a caregiver extends cover 510 over the underlying support, the weight of the corner cap and the anchoring component will pull the downwardly depending portion of cover 510 down. The caregiver can then guide the anchoring component over the anchor, for example, by grabbing the corner cap. When anchoring component 520 is over the anchor, the caregiver can move body 522 over the anchor using their tactile senses until anchor 524 is received in upper portion 522c. Once anchor 524 is received in upper portion 522c of opening 522a, which can be felt by the caregiver, the caregiver can then pull upwardly on cover 510, for example, by grabbing corner cap 540 to move anchor 524 into lower portion 522d and, thereby, secure the cover in place over the underlying support.

Optionally the structures may be reversed with the anchor structure attached to the cover, and the body attached to the underlying support.

Referring to FIG. 13, the numeral 610 designates another embodiment of a cover with an anchoring system 611. Anchoring system 611 includes an anchoring component 620 mounted in a panel 640 of flexible material, which is attached to cover 610. For example, panel 640 may be formed from a stretchy fabric material, such as a woven nylon or polyester knit. Anchoring component 620 includes a body 622 similar to body 522, which includes an opening 622a for receiving and engaging an anchor 624.

To further facilitate use of anchoring system 611, cover 610 may include a tether 650, which is joined to body 622. For example tether 650 may be formed from a loop of fabric that is joined with body 622, by molding, stitching, gluing or welding (such as ultrasonic welding or heat staking), depending on the tether and cover material. Similar to body 522, body 622 includes an opening 622a with a first portion 622c and a second portion 622d, which is smaller than first portion 622c. Body 622 may be formed from a flexible material, such as plastic or an elastomeric material, so that body 622 may be sufficiently flexible to form a snap fit or friction coupling with anchor 624, when anchor 624 is moved into the smaller, second portion of opening 622a. For further details of body 622 and anchor 624, reference is made to the previous embodiment.

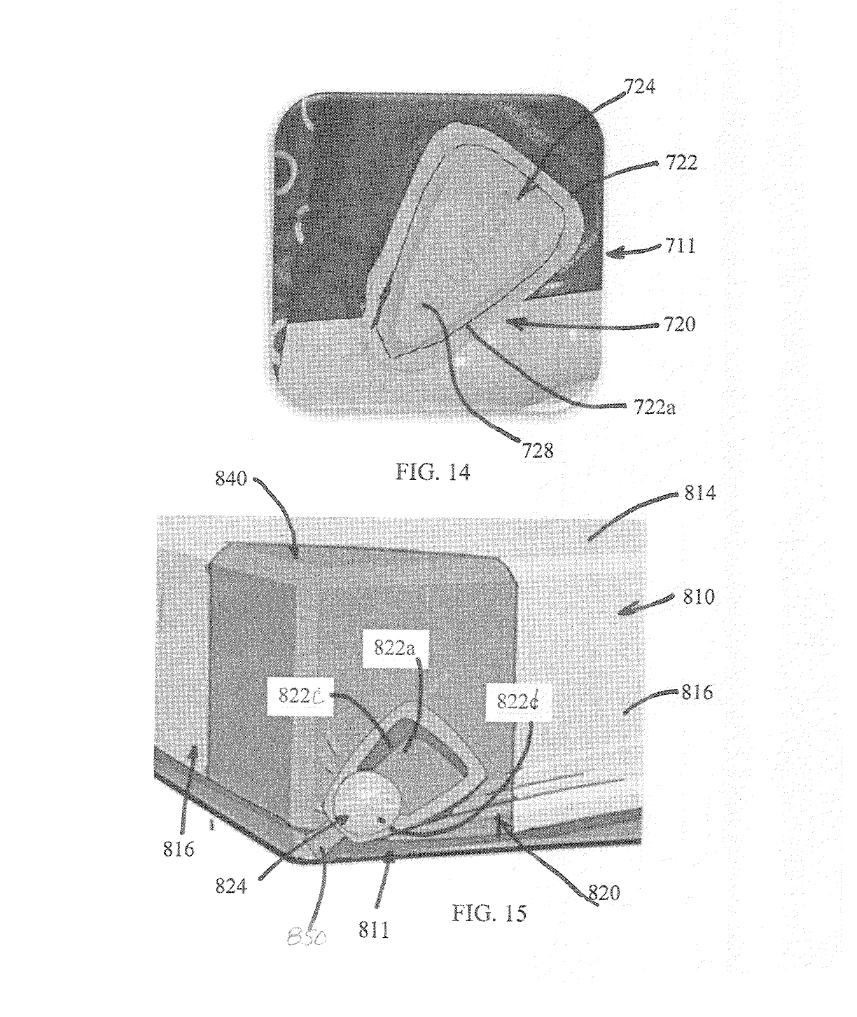

In yet another embodiment shown in FIG. 14, anchoring system 711 includes a body 722 with an opening 722a. Opening 722a is generally commensurate in size with anchor 724, but is sufficiently flexible to form a snap fit coupling with anchor 724 once opening 722a is aligned over anchor 724. Similar to anchor 524, anchor 724 includes an enlarged flange 728 that forms a lip that is sufficiently flexible to deflect when pressed, but returns to its prepressed state after anchor 724 has passed through opening 722a to thereby capture anchor 724 in body 722.

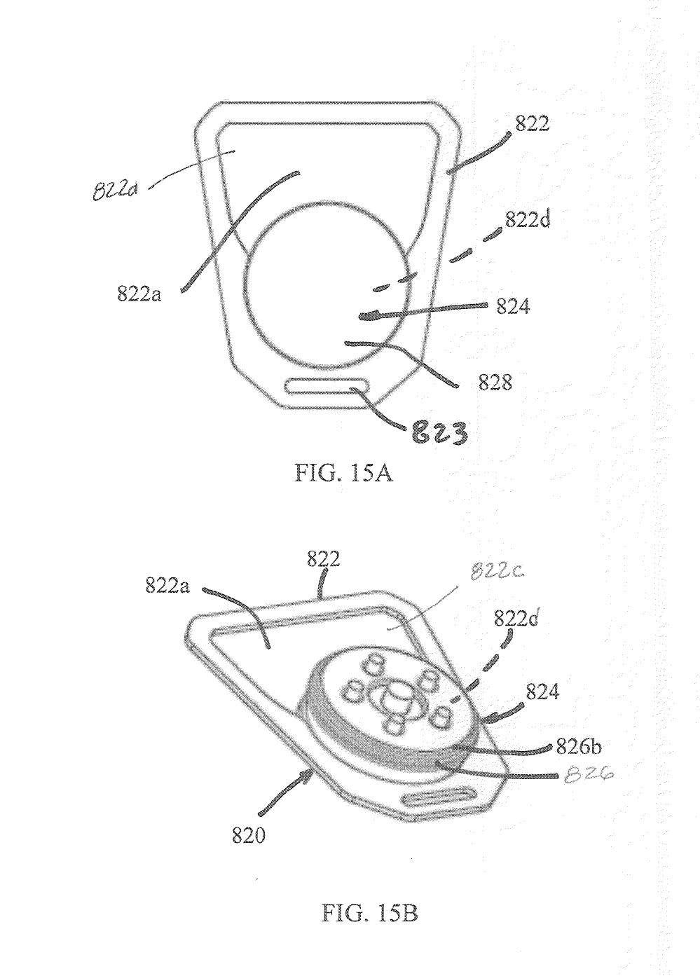

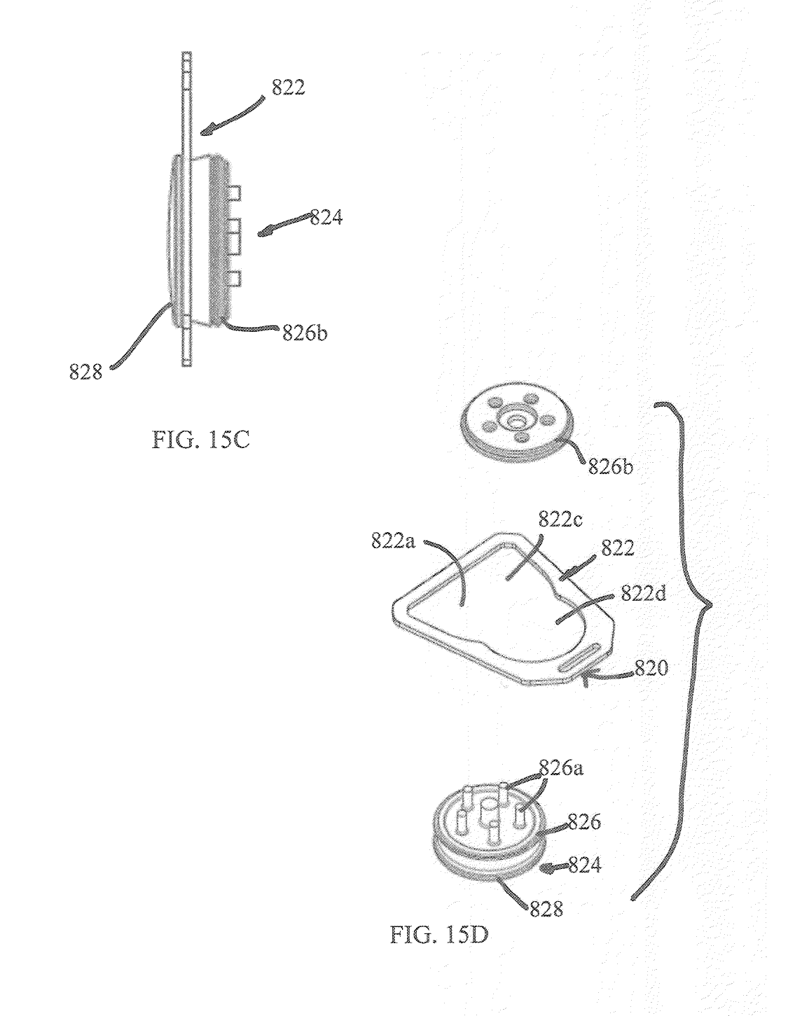

Referring to FIG. 15, the numeral 810 generally designates yet another embodiment of a cover with an anchoring system 811. Cover 810 includes a top panel 814 and depending portions 816, which are joined together by a reinforcing, but flexible corner 840. The material forming corner 840 may be similar to cover 810 and, further, may be elastic to facilitate placement of body 822 of anchoring system 811 over anchor 824, in a similar to the previous embodiments. Body 822 may also be formed from flexible material, such as a plastic or an elastomeric material.

While body 822 is similar to body 622 of anchoring system 611, body 822 is configured to receive a round anchor 824. Similarly, opening 822a of body 822 is shaped and sized so that anchor 824 may pass through upper portion 822c of opening 822, but is trapped when moved into lower portion 822d (FIG. 15A). In addition, cover 810 may also include a tether 850 to facilitate placement of cover 810 over the anchor (FIG. 15).

Referring to FIGS. 15B-15D, anchor 824 includes a base 826 and a projecting structure 827 with an enlarged flange 828, which forms an annular overhang to thereby form a lip for engagement by body 822 when anchor 824 is moved into lower portion 822d of opening 822. Anchor 824 may be welded (such as by ultrasonic welding or heat staking) onto the underlying support or may have projecting structures 826a for snap fit receipt into openings provided in a second base 826b, which is formed in or attached to the underlying support. For example, base 826b may also be formed from plastic and welded (such as by ultrasonic welding or heat staking), glued, stitched or otherwise attached to the underlying support. Further, body 822 may include an opening 823 (FIG. 15B), such as a slotted opening through which tether 850 may be looped to attach tether 850 to body 822.

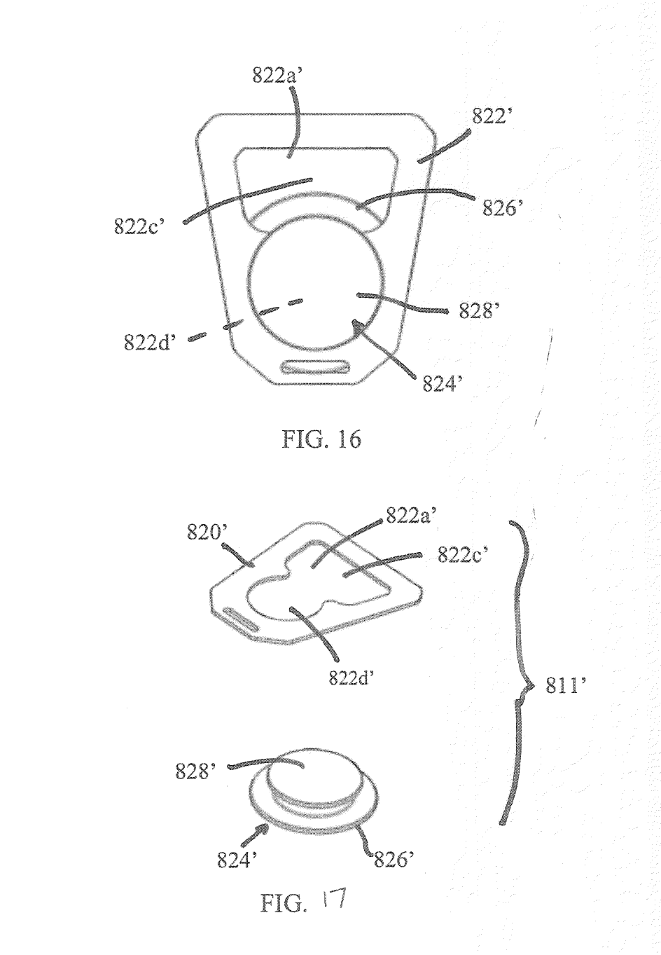

Referring to FIG. 16, the numeral 811′ generally designates yet another embodiment of the anchoring system of FIGS. 15 and 15A-15D. Anchoring system 811′ includes a body 822′ that is configured to receive a round anchor 824′. Similarly, opening 822a′ of body 822′ is shaped and sized so that anchor 824′ may pass through upper portion 822c′ of opening 822′, but is trapped when moved into lower portion 822d′ (FIG. 17).

Referring to FIG. 17, anchor 824′ includes a base 826′ and a projecting structure 827′ with an enlarged flange 828′, which forms an annular overhang to thereby form a lip for engagement by body 822′ when anchor 824′ is moved into lower portion 822d′ of opening 822′. In the illustrated embodiment, base 826 is glued or stitched to the underlying support. Further, body 822′ may include an opening 823′ (FIG. 17), such as a slotted opening through which tether 850′ may be looped to attach tether 850′ to body 822′.

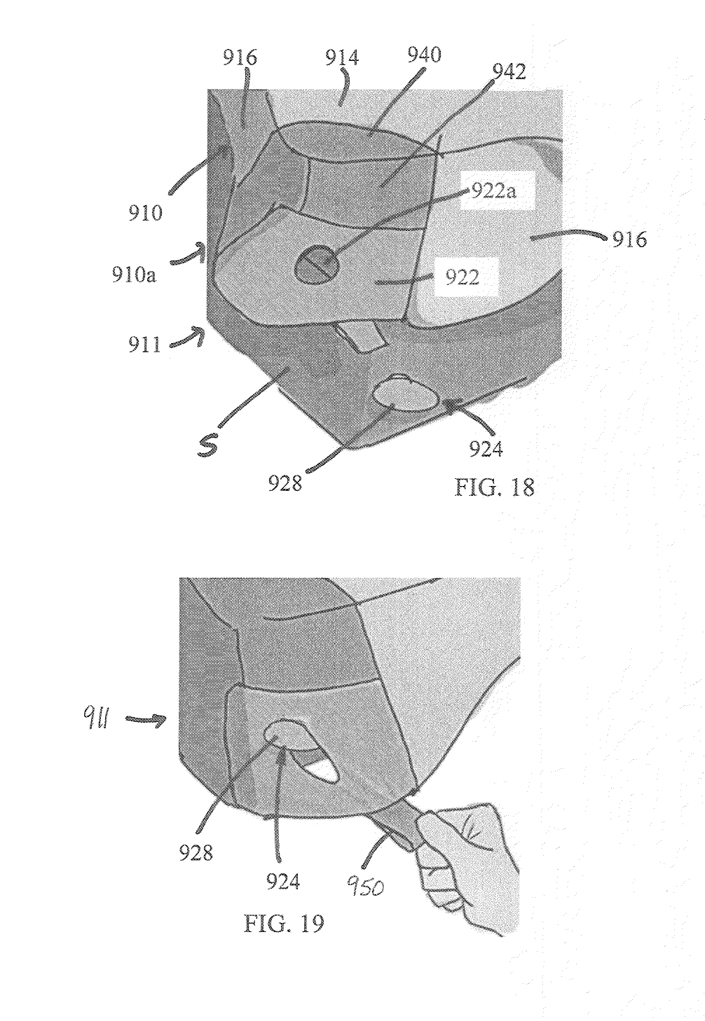

Referring to FIGS. 18-20, the numeral 910 refers to another embodiment of a cover. Cover 910 similarly includes a top panel 914 and a depending portion 916 extending from the top panel. Cover 910 also includes an anchoring system 911 for securing cover 910 to an underlying support. In the illustrated embodiment, anchoring system 911 includes a flexible body 922 mounted or formed on or in depending portion 916. Similar to the previous embodiments, body 922 includes an opening 922a and a tether 950 coupled to the body to facilitate positioning of the body relative to an anchor 924.

As best understood from FIGS. 18-20, when cover 910 is positioned over the support S and corner 910a of cover 910 is aligned with the corner of the support S, body 922 can be pulled over anchor 924 by tether 950. Further, body 922 may be formed from a stretchy material, such as a knit or an elastomeric material. Thus, when tether 950 is pulled, opening 922a may be stretched and enlarged to facilitate the engagement of anchor 924. Once tether 950 is released, opening 922a will return to its pre-stretched configuration (which is sized to be smaller than the anchor 924 (or at least a portion of anchor 924), so that body 922 will then trap anchor 924 in opening 922a.

As best understood from FIG. 18, body 922 may form part of corner 940 of cover 910 and may be joined with balance of cover 910 by stitching, welding, heat staking, or molding, depending on the materials forming cover 910 and body 922. In addition, cover 940 may be reinforced by a panel 942, which either overlaps or joins depending portions 916. In this embodiment, body 922 may be joined with panel 942. For example, panel 942 may be formed from nylon or a polymeric based material or an elastic material, such a woven nylon or polyester knit.

Similar to the previous tethers, tether 950 may be formed from a loop of material, which is secured to body 922 by stitching, welding, heat staking, molding, or the like, depending on the materials forming body 922 and tether 950. As best seen in FIG. 18, anchor 924 may include an enlarged flange 928, which forms an overhang relative to the balance of anchor 924 to thereby form a lip to engage body 922, similar to the previous embodiments.

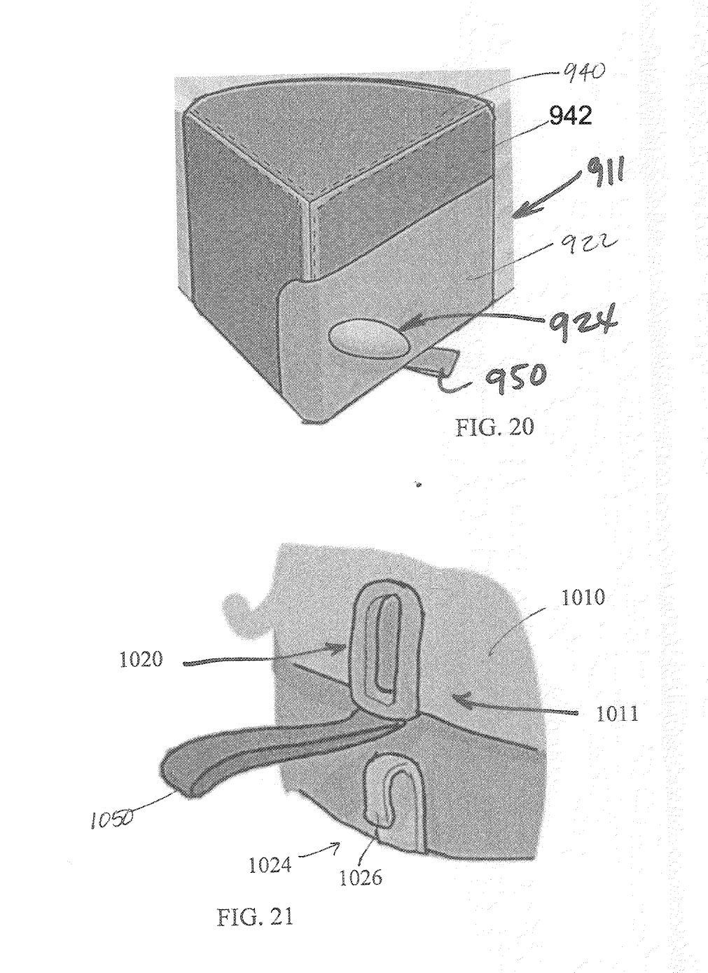

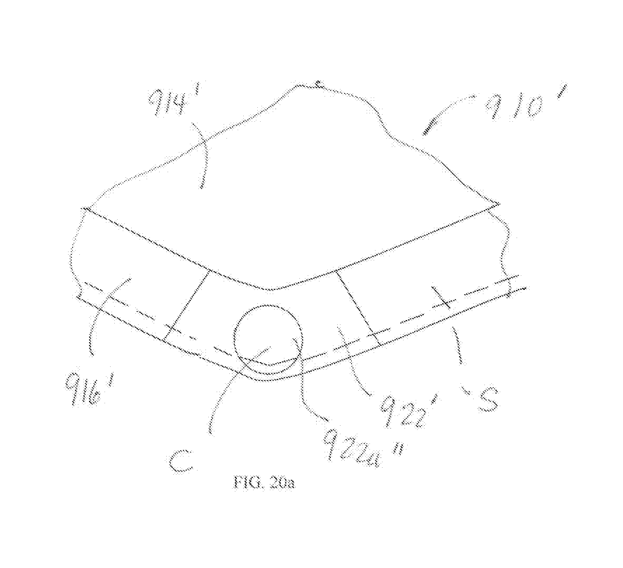

Referring to FIG. 20a, the numeral 910′ refers to another embodiment of a cover. Cover 910′ is similar to cover 910 and includes a top panel 914′ and a depending portion 916′ extending from the top panel. Cover 910′ also includes an anchoring system for securing cover 910′ to an underlying support S. In the illustrated embodiment, the anchoring system also includes a flexible body 922′ mounted or formed on or in depending portion 916′. Similar to the previous embodiments, body 922′ includes an opening 922a′ to facilitate positioning of the body relative to support surface S.

As best understood from FIG. 20a, when cover 910′ is positioned over the support S and the corner of cover 910′ is aligned with the corner C of the support S, body 922′ can be pulled over corner C of support S and further stretched so that opening 922a′ either engages the lower portion of corner C of support S or the upper portion of corner C of support S, or the whole corner C. As described above, by forming body 922′ from a stretchy material, such as a knit or an elastomeric material, opening 922a′ can be stretched as needed, and further thereby form a friction fit with the corner of the support surface S. Optionally the opening 922a′ may include one or more regions or a ring of high friction material (such as gel or thermoelastomer glued, welded or molded on to the inner facing side of the cover) to further facilitate it retention on support S.

In another embodiment, as shown in FIG. 21, a cover 1010 includes an anchoring system 1011 that includes an anchoring component 1020 in the form of a looped shape body 1022 and an anchor 1024 with a hooked portion 1026. Again body 1022 may be coupled to a tether 1050, which can be used to pull body 1020 over anchor 1024 to located opening 1022a over anchor 1024 and engage hooked portion 1026.

In the illustrated embodiment, body 1022 is mounted along a side of cover 1010; however, it should be understood that body 1022 may also be located at or near a corner of cover 1010.

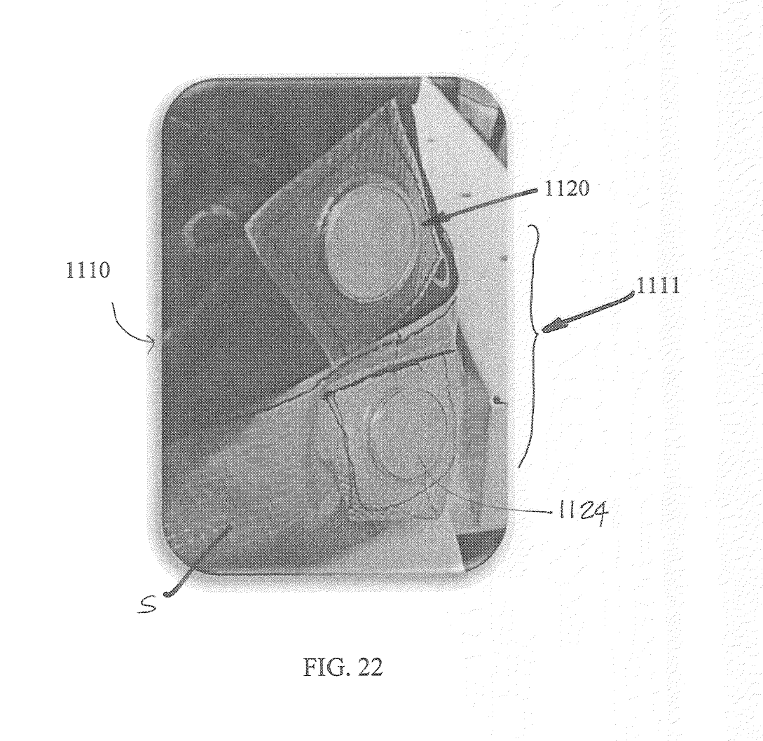

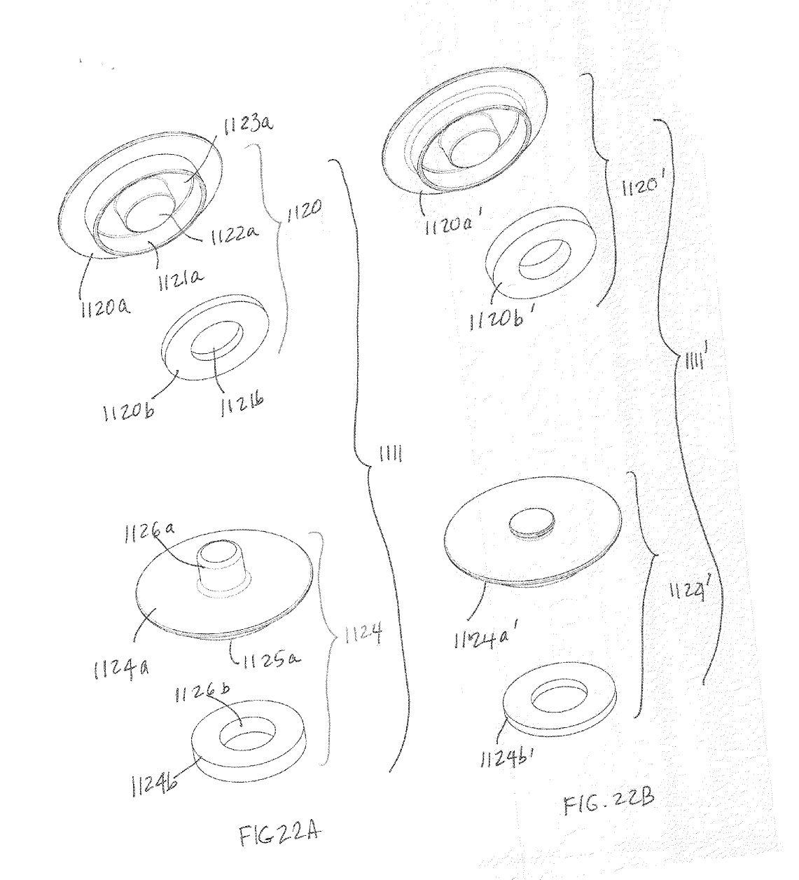

Referring to FIG. 22, the numeral 1110 designates yet another embodiment of a cover. Cover 1110 similarly includes an anchoring system 1111 with two couplers 1120 and 1124 that releasably couple together. Further, at least one of couplers 1120, 1124 is adapted to guide itself into engagement with the other coupler. For example, one of the couplers comprises a magnet, with the other couple being formed by magnetic material, such as carbon or stainless steel body. Optionally, each coupler may comprise a magnet.

For example, coupler 1120 may be mounted to a depending portion 1116 of cover 1110, while coupler 1124 may be mounted to the outer surface of support S. For example, coupler 1120 may be mounted to an extension of depending portion 1116, for example, on the inside of the extension. In this manner, when a caregiver positions cover 1110 over the underlying support and coupler 1120 is generally aligned over coupler 1124, coupler 1120 will be attracted to coupler 1124 under the influence of the magnetic field produced by the magnet or magnets to thereby guide coupler 1120 into engagement with coupler 1124.

Referring to FIG. 22A, coupler 1120 may be formed from a base 1120a with an upstanding annular wall 1121a and an inwardly spaced, hollow post 1122a, which define there between an annular space 1123a. For example base 1120a may be formed from plastic. Positioned in space 1123a is a magnet 1120 in the form of an annular body (ring magnet) with a central opening 1121b sized to receive post 1121a. Coupler 1124 includes a base 1124a with an annular wall 1125a about which a magnetic annular member 1124b (such as a carbon steel or stainless steel member) with a central opening 1126b is located. For example, the various components of each may be molded together or glued together, or have a snap fit construction. Further, the base of each couple may be sewn, heat staked or glued to its corresponding cover or underlying support.

Projecting from base 1124a of coupler 1124 is a locating or guiding post 1126a, which is sized to extend into hollow post 1122a. In this manner, the interaction of the two posts forms a mechanical coupling between the two couplers in addition to the magnetic coupling. Though it should be understood that each coupler 1120 and 1124 may be simply formed from magnets or magnetic members that are sewn into or heat staked or glued into their respective cover or support.

Alternately, as shown, coupler 1120′ may have a magnetic annular member 1120b′ mounted to its base 1120a′, and coupler 1124′ may have the ring magnet 1124b′ mounted to its base 1124a′. Further, base 1124a′ may have a raised central region that is sized to extend at least partially into the hollow post of coupler 1120′ rather than a post.

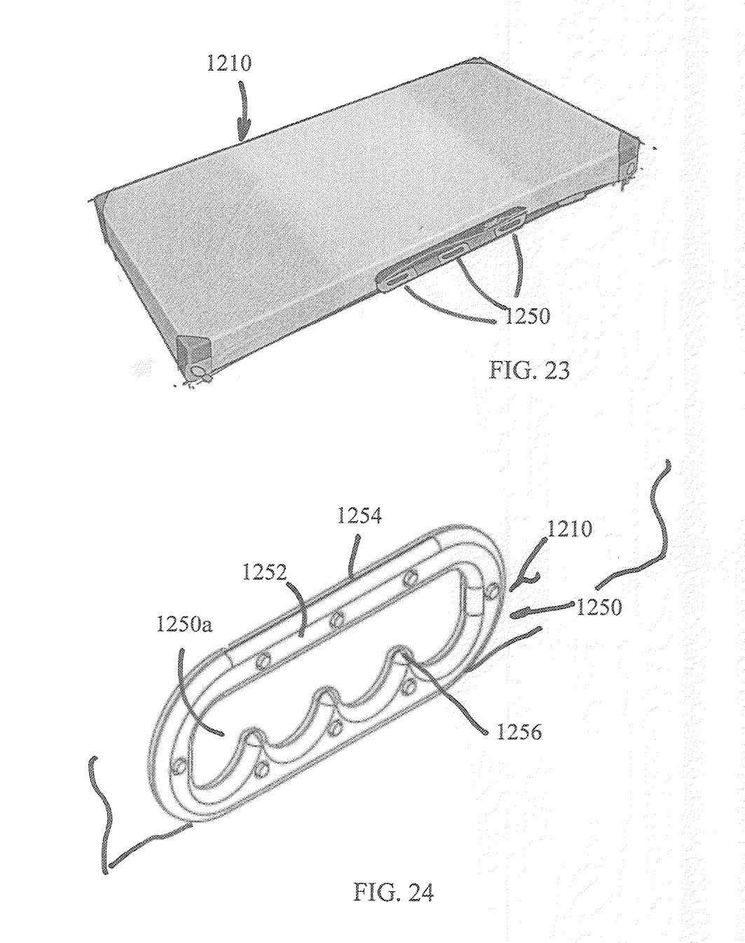

Referring to FIG. 23, the numeral 1210 generally designates yet another embodiment of a cover. Cover 1210 is configured to facilitate the movement or transfer of a patient relative to an underlying support by providing one or more structures that can be gripped by a caregiver. For example, in one embodiment, cover 1210 may include one or more polymeric bodies 1250 attached along one or more edges of cover 1210. Bodies 1250 may be heat-staked or configured to have a snap-on construction with cover 1210.

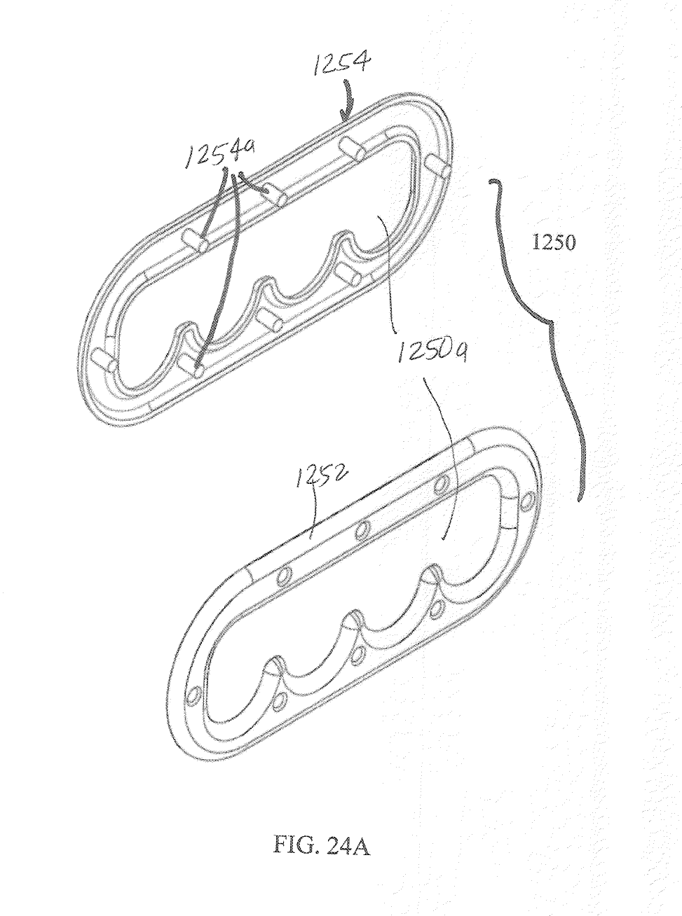

Referring to FIG. 24, body 1250 is configured as a hand hold. To that end, body 1250 includes an opening 1250a that is sized to receive a caregiver's hand. As noted above, body 1250 may be heat-staked onto cover 1210. For example, body 1250 may be formed with a split construction, with a first part 1252 of body 1250 being joined with cover 1210 by heat staking, welding, molding, or gluing, and a second part 1254 configured to form a snap fit with the first part 1252. For example, second part 1254 may be formed, such as by molding, with projecting structures 1254a to extending in to corresponding recesses or openings in part 1252 to form a snap fit with first part 1252.

To facilitate gripping of body 1250, body 1250 may include several raised ridges 1256 that generally correspond to the spaces between a caregiver's fingers. Ridges 1256 allow for greater control over cover 1210 in that they provide additional bearing surfaces to generate torsional forces on cover 1210, which may be useful when trying to move or turn a patient.

Referring again to FIG. 23, bodies 1250 may be located at a lower edge of a depending portion 1216 of cover 1210, so that they are not likely to be detected by a patient supported on cover 1210. Cover 1210 may also include one or more anchoring components that cooperate with anchors mounted to the underlying support to form an anchoring system for the cover as well. For examples of suitable anchoring systems, reference is made to the above embodiments.

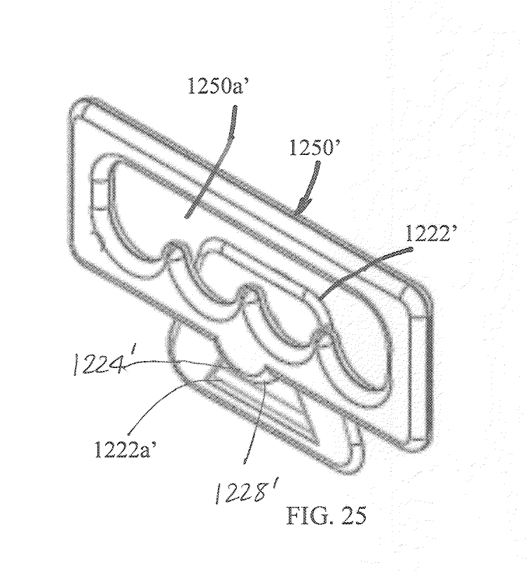

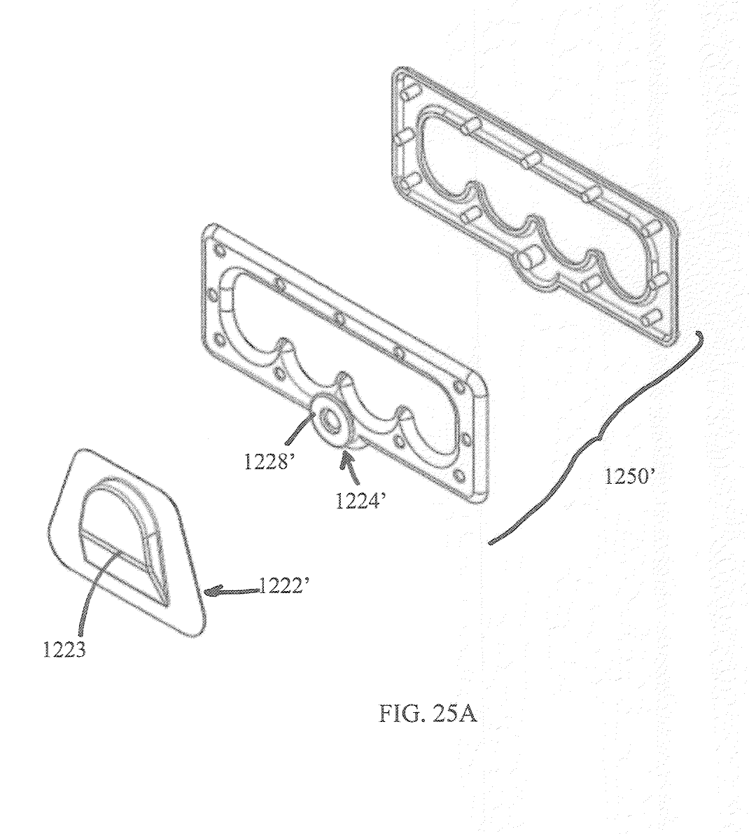

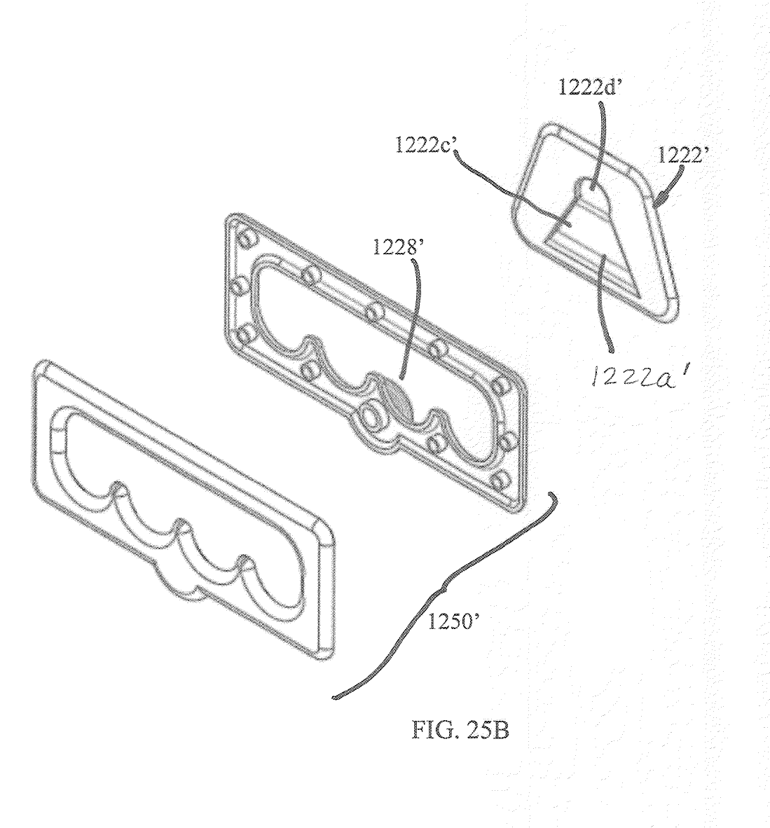

Alternately, or in addition, as shown in reference to body 1250′, which also forms a hand hold, body 1250′ may be adapted/configured to engage an anchor that is attached to the underlying support under the cover. For example, body 1250′ may include an opening 1250a′ that is similar to opening 1250a and configured to receive a hand of a caregiver. It too may include ridges to increase the bearing surface area for the caregiver's hand. As best seen in FIG. 25A-25B, body 1250′ includes a projecting structure 1224′. For example, projecting structure 1224′ may be of similar construction to the anchors described above. Structure 1224′ is adapted to engage a receiving body 1222′ mounted to the underlying support. For example, receiving body 1222′ may include a recess 1223′ with an opening 1222a′ that includes a first portion 1222c′ and a second portion 1222d′ smaller than first portion 1222c′ to trap structure 1224′ in recess 1223′ when structure 1224′ is moved into opening 1222a′ at portion 1222c′ and then moved into portion 1222d′. Similar to the previously described anchors, structure 1224′ includes an enlarged flange 1228′ to form a lip for engagement by body 1222′, in a similar manner as the anchors described above.

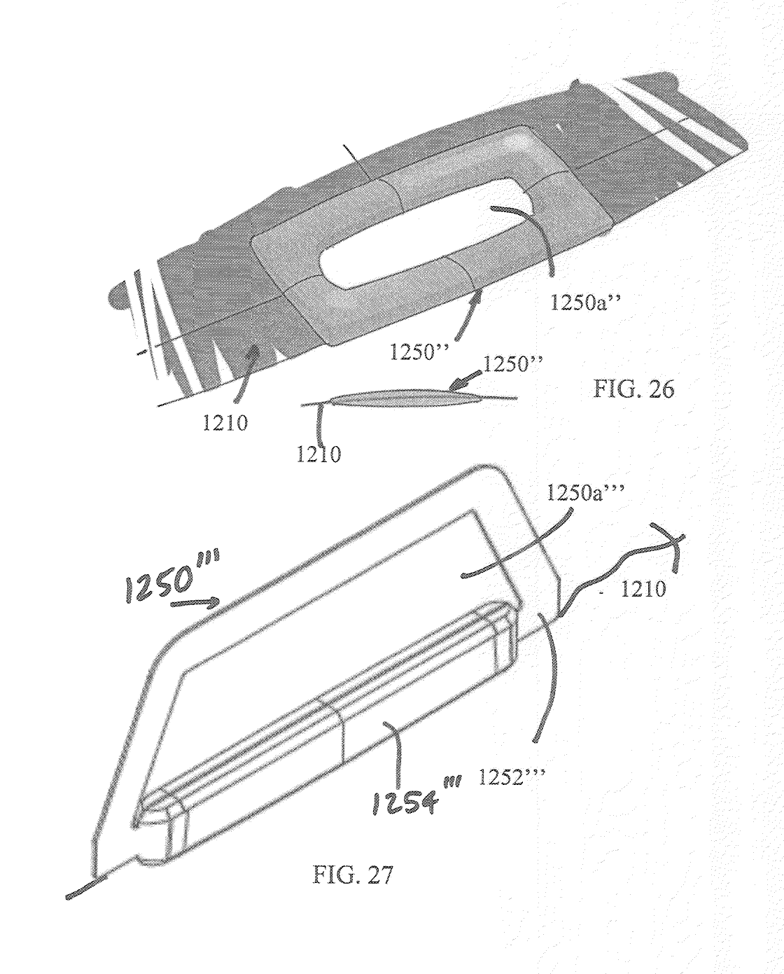

Additional embodiments of hand holds are shown in FIGS. 26-28. Referring to FIG. 26, handhold body 1250″ comprises an over molded hand hold. For example, body 1250″ may be formed from an elastomer and over molded along an edge of cover 1210. Optionally, body 1250″ may be formed with a central opening 1250a″ and with a tapered cross-section, but with generally equal thickness in the plane of cover 1210. Body 1250″ may be reinforced, for example, similar to body 1250′″ described below.

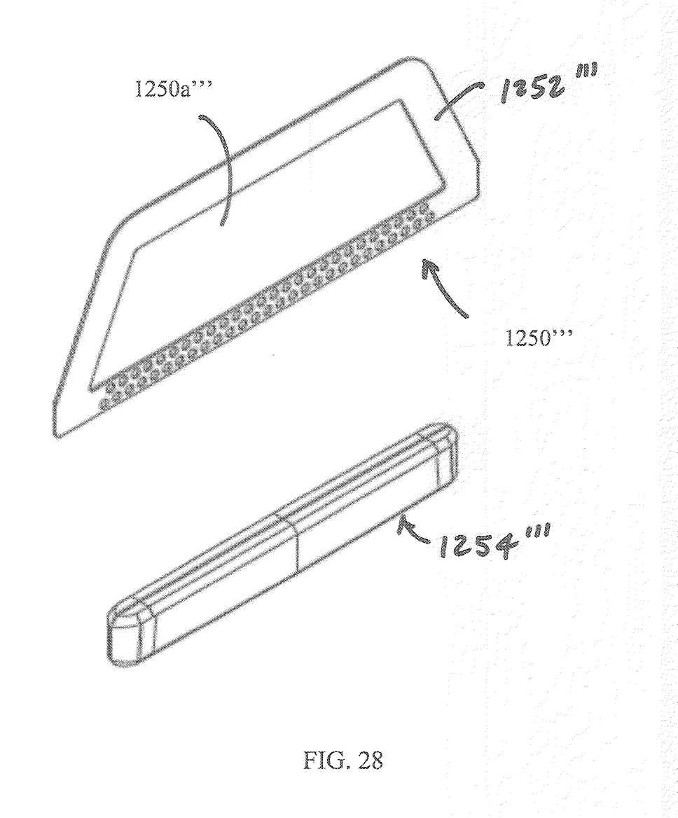

Referring to FIGS. 27 and 28, hand hold body 1250′″ may be formed by a frame 1252′″ that has a closed loop construction, for example, a trapezoidal shaped loop. Frame 1252′″ may be inset molded in cover 1210 and, optionally, includes a reinforced section 1254′″, such as the lower section of the frame, with an elastomeric body to form a grab handle portion 1256′″. For example, when molded into cover 1210, a portion of the opening 1250a′″ may be exposed to allow a caregiver's hand to extend into and through frame 1252′″ to wrap their fingers around grab handle portion 1256″.

Alternately, edge of cover 1210 may incorporate one or more strips of over molded elastomeric material to provide a gripping surface on the cover. For example, each strip may be formed from an elastomeric material such as natural rubber, an isoprene rubber, a styrene-butadiene rubber, a nitrile rubber, a silicone rubber, ethylene propylene rubber (EPM), ethylene propylene diene rubber (EPDM), or a thermoplastic elastomer (TPE) or the like and have a thickness in a range of 1 to 1/16 inch or ¾ to ⅛ inch, for example.

As shown in FIG. 23, cover 1210 may include a top panel 1214 and downwardly depending portions 1216, 1218 that extend from and along the longitudinal edges of top panel 1214 and from and along the lateral edges of top panel 1214. Portions 1216 and 1218 may be formed from extensions of top panel 1214 or may be formed from separate panels. Further, portions 1216, 1218 may be joined at their respective corners directly or by way of the corners or corner caps described above. The elastomeric strips may be located adjacent the free edges of portions 1216 or 1218 and, further, extend partially along their lengths or along their full lengths. Additionally, multiple elastomeric strips may be provided on each portion, for example, in a parallel spaced arrangement. In this manner, a caregiver may grab the edge of cover 1210 and grip the cover by gripping the elastomeric strips. Further, when bunched together, the strips can provide an even larger gripping surface.

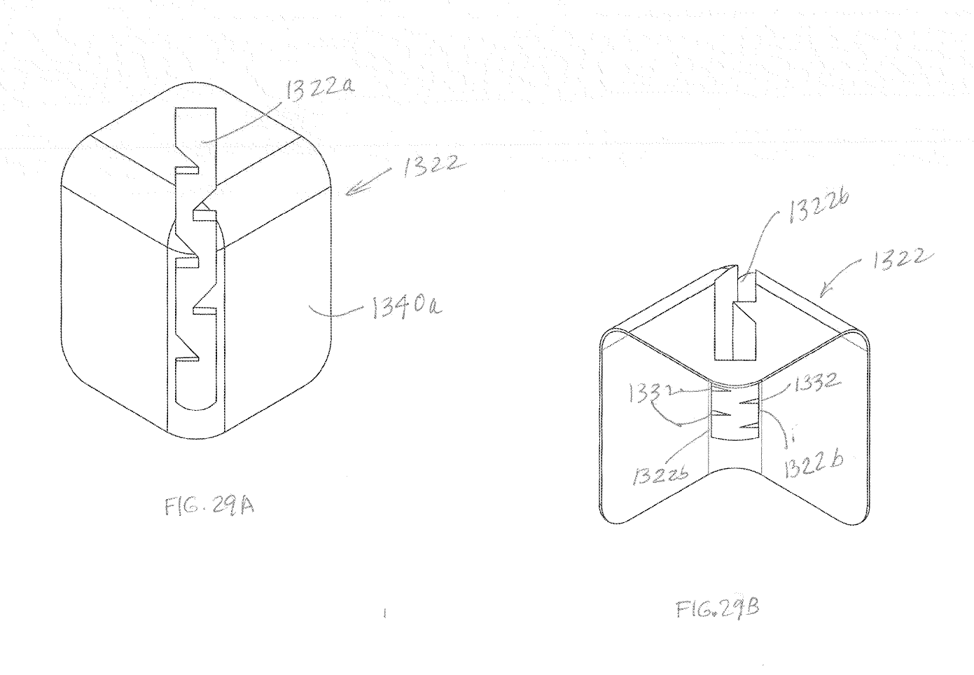

Referring to FIGS. 29A, 29B, 30A, and 30B, another embodiment of an anchoring system with two couplers that guide each other into engagement and releasably engage each other coupler. In the illustrated embodiment, the two couplers are configured as two bodies 1322 and 1324, which are configured to couple and engage each other when aligned. In the illustrated embodiment, each body 1322 and 1324 is formed in a corner cap 1340a and 1340b so that alignment of the two bodies is further simplified so that when the corner caps are aligned, the two bodies will be aligned so that they can be moved into engagement with each other.

For example, body 1324 is mounted to or formed as one of the corners of the underlying support, while a body 1322 is mounted to or formed as one of the corners of the cover and when positioned over body 1324 and aligned therewith will anchor the cover to the underlying support.

In the illustrated embodiment, each body 1322, 1324 has inverted or recessed corners to thereby form a recess 1324a on body 1324 and recess 1322a on body 1322. Recess 1332a is defined between rearwardly projecting spaced walls 1322b that are sized to fit in recess 1324a of body 1324. Further, walls 1324b that define recess 1324a include guide surfaces 1328 that guide walls 1322b into recess 1324a. Additionally, walls 1342b further define engagement surfaces 1330 for engaging walls 1322b when body 1322 and 1324 are aligned and walls 1322b are received in recess 1342a. Similarly, walls 1322b include receiving structures 1332 in the form of recesses into which engagement structures extend when the two bodies are aligned and engaged.

Thus similar to the previous embodiments, at least one of the couplers has a guide surface to guide the other coupler into engagement with each other.

Corner caps 1340a and 1340b may be welded, glued, molded, stitched or otherwise secured at the corners of the underlying support and the cover, respectively.

Alternately, body 1324 may form a cleat into which the cover sheet may be bunched and then secured by the projecting structure in recess 1342a.

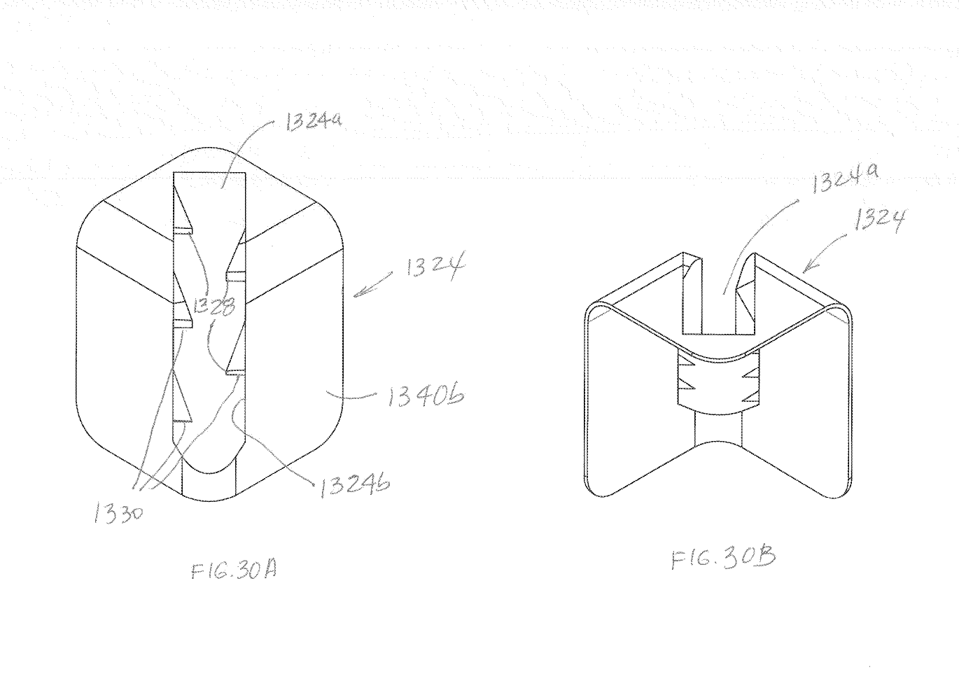

Referring to FIGS. 31A and 31B, a simplified cleat-based anchoring system is shown. The cleat-based anchoring system includes a body 1424 that is attached to a cover and that forms an anchor for a line, such as bungee, which attached to the underlying support. Though it should be understood that the line may be attached to the cover and the anchor may be attached to the underlying support. Similar to the other anchors, anchor 1424 includes a base 1426 and a projecting body 1427 with an enlarged flange. The enlarged flange 1427 may form an overhang for securing the line to the anchor more fully described below. Base 1426 may be sewn, heat staked, molded or otherwise attached to the underlying support.

Flange 1428 is split to form a recess or channel 1430 that extends across flange 1428 to receive a line therein. For example, line may be frictionally held in channel 1430 or may be wrapped around projecting body 1427 in another channel 1427a to secure the line to anchor 1424.

In any of the above anchoring systems, the anchors and bodies may be molded from plastic and may be secured to the respective components by stitching, heat staking, welding molding, or other known techniques and any improved methods that may be developed in the future.

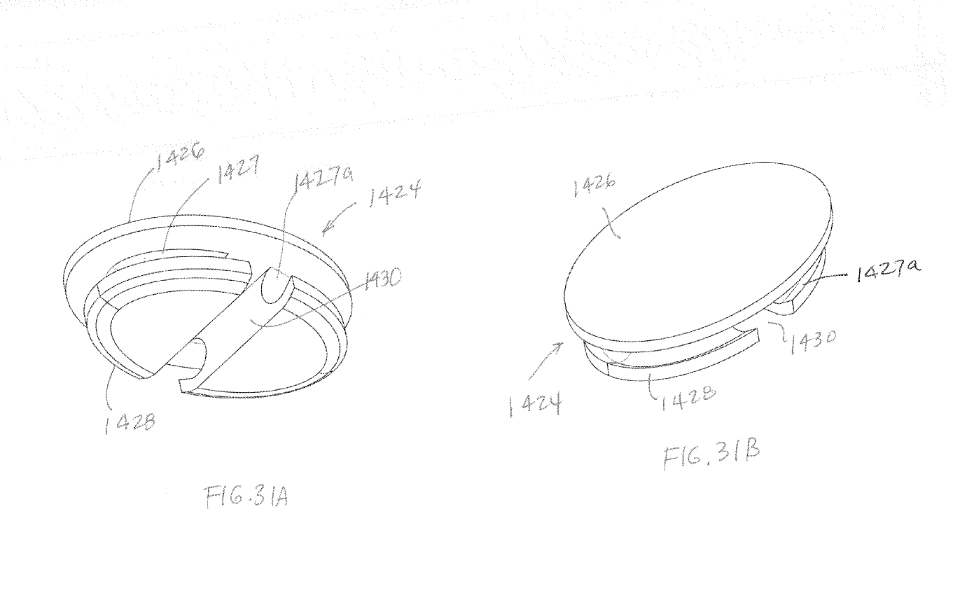

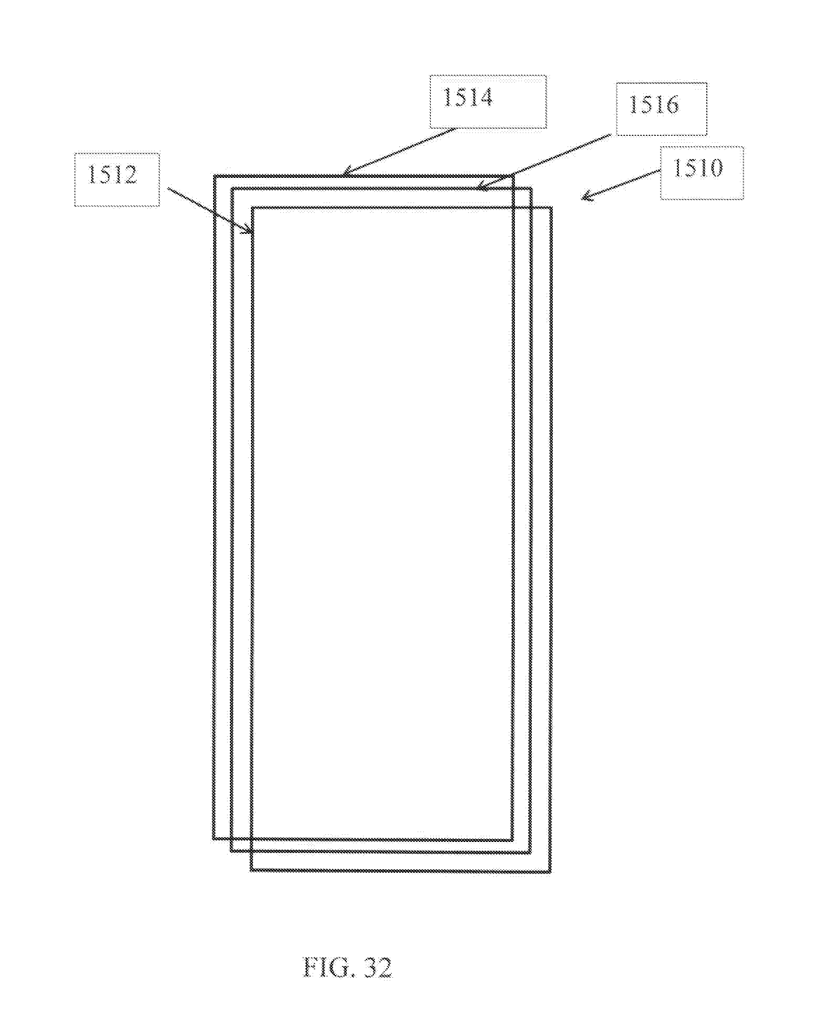

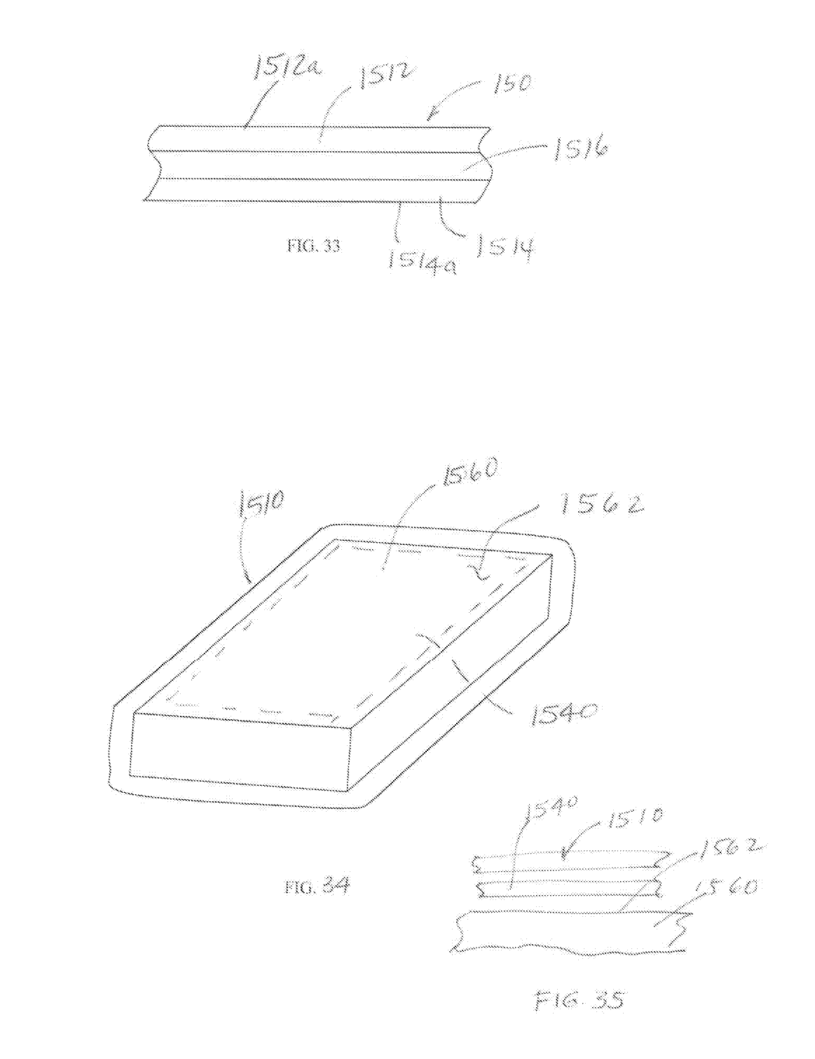

Referring to FIG. 32 the numeral 1510 generally represents another embodiment of a cover that is suitable for use on a patient support surface, such as a mattress, and facilitates the transfer of a patient across the patient support surface. Cover 1510 optionally covers the entire surface of the patient support surface and includes a top layer 1512 and a bottom layer 1514. For example, cover 1510 includes lateral side edges 1510a, 1510b that extend the length of cover 1510 and end edges 1510c, 1510d that extend across the width of the cover. The lateral side edges 1510a and 1510b are spaced apart by the width of the underlying support surface, e.g. the width of the underlying mattress. Similarly, the end edges are spaced apart by the length of the underlying patient support surface, e.g. the length of the underlying mattress. Alternately, the cover may be longer or wider than the underlying support surface so that the sides and ends of the cover may be tucked under the patient support surface.

Top layer 1512 is formed from a material that provides a soft comfortable upper surface 1512a for a patient, such as formed from a layer of knit material, including cotton, polyester knit, a cotton/polyester blend, or other blends, or the like. A suitable knit may be a knit that can wick or transport moisture away from the interface between the patient's skin and the cover, to thereby reduce the chances of developing a pressure sore or ulcer. For example, polyester knit may be a suitable material to form the top layer and provide a wicking function.

To facilitate transferring, and moreover reduce the effort needed to move a patient supported on cover 1510 across a patent support surface, bottom layer 1514 forms a slippery surface 1514a. For example, the slippery surface 1514a may be formed by physically or chemically altering the bottom surface of layer 1514, for example, by calendaring or ironing. In addition or alternately, layer 1514 may include a silicone layer to form the slippery surface. The silicone layer may be applied to the cover, for example, by spraying, rolling, or the like. Another suitable bottom layer may be provided by a layer of nylon.

Cover 1510 optionally further includes a middle or intermediate layer, which may be configured to allow moisture but not fluid be carried from the upper surface to the bottom surface. For example, the intermediate layer may be formed from a polyester knit or other knit, which is air and moisture permeable, but fluid impermeable. Exemplary materials include an EPTF membrane, urethane membrane, hydrophobic materials, an osmosis membrane or materials that wick moisture away by capillary action. When moisture has moved from the skin into the intermediate layer, the moisture will have more surface area and will evaporate faster. Natural materials that wick away moisture include wool and silk. Synthetic materials include polyester, polyethylene, and microfiber-based fabrics, such as fabrics sold under the trademark GORTEX.

The various layers formed cover 1510 may be laminated together using adhesive or may be joined by stitching, welding or the like.

Cover 1510, therefore, provides a patient facing side that forms a soft interface for the patient while protecting the surface on which the patient is supported by not allowing fluid to go through the cover. Further, with the patient support surface facing side being slippery allows the cover to provide a patient transfer or movement function. At the same time, as noted, cover 1510 may be configured to wick away moisture to reduce the chances of developing pressure ulcers. In this manner, the cover may be simply wiped down using a disinfectant to keep the cover clean.

In addition, cover 1510 may include an antimicrobial treatment, for example metallic ions, such as silver ions, or MICROBAN may be incorporated into one or more of the layers of cover 1510.

Further, cover 1510 is formed from a thin layer or layers that are sufficiently flexible and supple so that cover 1510 can be tucked under the patient support surface, e.g. under a mattress, and also be rolled or folded like a common bed sheet for storage. Additionally, cover 1510 may be disposable and may be made from recyclable materials, including polyester, nylon, and/or may be launderable.

In this manner, cover 1510 may be used as an underlying sheet for a patient, which can then be used to move or transfer a patient across a support surface, while reducing the stress and strain on a caregiver by reducing the friction between the cover and the underlying patient support surface.

Additionally, cover 1510 may be formed from radiolucent materials, such as plastic with constant thicknesses, so that cover 1510 can remain under the patient even when being X-rayed or scanned using other technologies.

Referring to FIGS. 34 and 35, alternately, the slippery or low friction interface between the cover and the underlying patient support surface may be provided by a separate layer 1540 interposed between the cover 1510 and the patient support surface 1560 or on the upwardly facing surface 1562 of the patient support surface. Optionally, two or more or each of the cover 1510, interface 1540 and upper surface 1562 of patient support surface 1560 may include or be formed with a slippery surface. For example, as noted, the slippery surface may be mechanically formed or applied, such as by coating, to an underlying substrate.

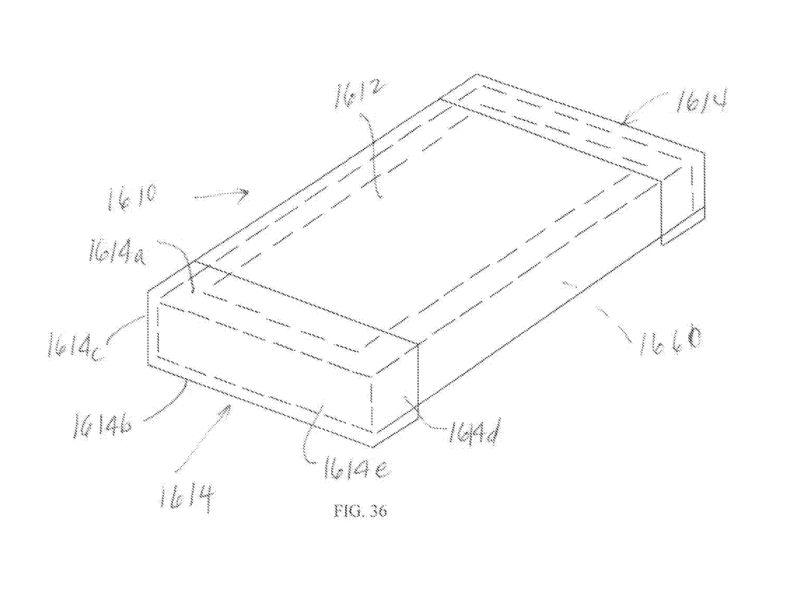

Another embodiment of a cover assembly 1610 is illustrated in FIG. 36. Cover assembly 1610 includes a cover 1612, which is joined with or attached to opposed end attachments 1614. Cover 1612 may be constructed as described in reference to cover 1510 to facilitate transfer the patient and, optionally, to reduce moisture build up at the interface between the patient and the cover. Attachments 1614 are configured to secure cover 1612 to the underlying patient support surface 1660 but not restrain and instead provide freedom of movement to cover 1612 so that cover 1612 may shift across the patient support surface 1660 to facilitate, for example, boosting of a patient toward one end of patient support surface 1660. For example, attachments 1614 may be formed from a stretchy material, such as spandex, which in effect forms springs, as noted to allow cover 1613 to shift relative to the patient support surface. For example, attachments 1614 may be made from a material that provides for an elongation of 18 inches so that the sheet can move over a distance in a range of 6 to 18 inches.

The shape of attachments 1614 may vary. For example, in the illustrated embodiment, attachments 1614 have a cap-shape with an upper panel 1614a and a bottom panel 1614b, which are joined together by two opposed side panels 1614c and 1614d and an end panel 1614e so that attachment 1614 covers the end of the patient support. Optionally, each of the respective panels are each formed by a stretchy or elastic material and are sized so that attachments 1614 must be stretched in order to be placed over the respective ends of the patient support surface, which then frictionally retains attachments 1614 onto the ends of the patient support surface.

Cover 1612 may be joined with attachments 1614 by way of a variety of attachment mechanisms, such as Velcro patches or strips, a zipper, snap couplers, magnets or the like. Cover 1612 may be sized to cover just the top surface of the patient support surface or sized so it so that it wraps around and extends down the sides of patient support surface 1660. Furthermore, an additional sheet 1680 may be placed over cover 1612 to provide the interface with the patient supported thereon.

Alternately, the attachment between the cover 1612 and attachments 1614 may provide the freedom of movement. For example, the attachment mechanisms may include elastic bands or straps that include attachment devices, for example, on either ends of the band or strap to connect the cover to the respective attachment to allow the cover to move relative to the attachments.

In addition, attachments 1614 may include a mechanism to cinch the attachments to the respective ends of the patient support surface. For example, each attachment 1614 may include a cord extending through a loop or loops formed in the respective attachments, for example, around the free edges of the upper, lower and side panels, which cords can then be tightened secure the attachments to the respective ends of the patient support surface.

Referring to FIGS. 37-39, the numeral 1710 generally designates another embodiment of the cover. Cover 1710 may be formed or constructed as described above in reference to covers 1510 or 1610 and is further configured to provide directional sliding. Patients with pneumonia are often supported with the head of bed angle approximate 30°. As a result, most people will slide toward the foot end of the bed under the influence the force of gravity. While a low friction surface may provide advantages and make it easier to boost a patient back up toward the head end of a bed, the same low friction surface will allow gravity to pull the patient back down toward the foot end of the bed.

To combat this, lower surface 1714a may include a bidirectional region or section 1720 that is configured to provide a first coefficient of friction in a first direction and a second coefficient of friction, which is different than the first coefficient friction, in a second direction opposed from the first direction. This will allow the cover to have a low friction surface to boost the patient but then remove or reduce the low friction surface so the patient will not slide back down to the foot end of the bed.

For example referring to FIG. 38, region 1720 may include a plurality of flaps 1722 that include on one side a slippery surface 1722a and on an opposed side a non-slippery, and optionally a sticky, surface 1722b. So for example when cover 1710 is pulled in the direction indicated by arrow 1715a (FIG. 37), flaps 1722 will fold against lower surface 1714a so that the slippery surfaces of the flaps form a slippery surface for cover 1710, which will facilitate, for example, boosting the patient in the direction indicated by arrow 1715a. On the other hand, if cover 1720 is pulled in the direction indicated by arrow 1715b, flaps 1722 will fold in the opposite direction so that the non-slippery or sticky surfaces of the respective flaps thereby form a non-slippery or sticky surface for cover 1720, which will help resist gravitational forces that tend to pull the patient toward the foot end of the bed.

Alternately, the bidirectional region 1720 may be formed by a particular weave with a particular fiber orientation in the layer forming the lower surface 1714a of cover 1710. For example, bottom layer 1714a may be formed from a material that is woven to make it bidirectional. In another embodiment, the lower surface 1714a of cover 1710 may have a surface applied to lower surface 1714a that forms the bidirectional region. For example, a suitable applied surface may include silk screening, injection molding, printing or the like.

For example referring to FIG. 40, cover 1710 may be used in combination with one or more positioners, such as a wedge-shaped block 1790. Block 1790 may, for example, be formed from foam and may be placed under a patient's feet or under a patient's head and shoulder region. In this application, cover 1710 may be significantly reduced in size and be placed on one side 1792 of the wedge-shaped block 1790.

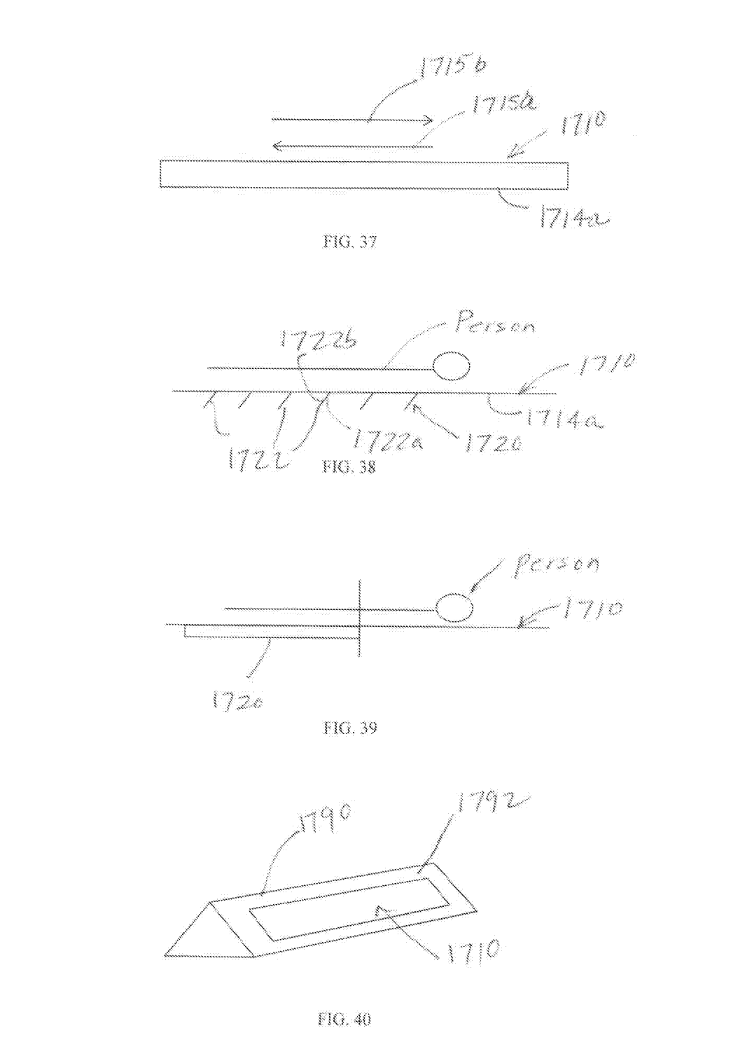

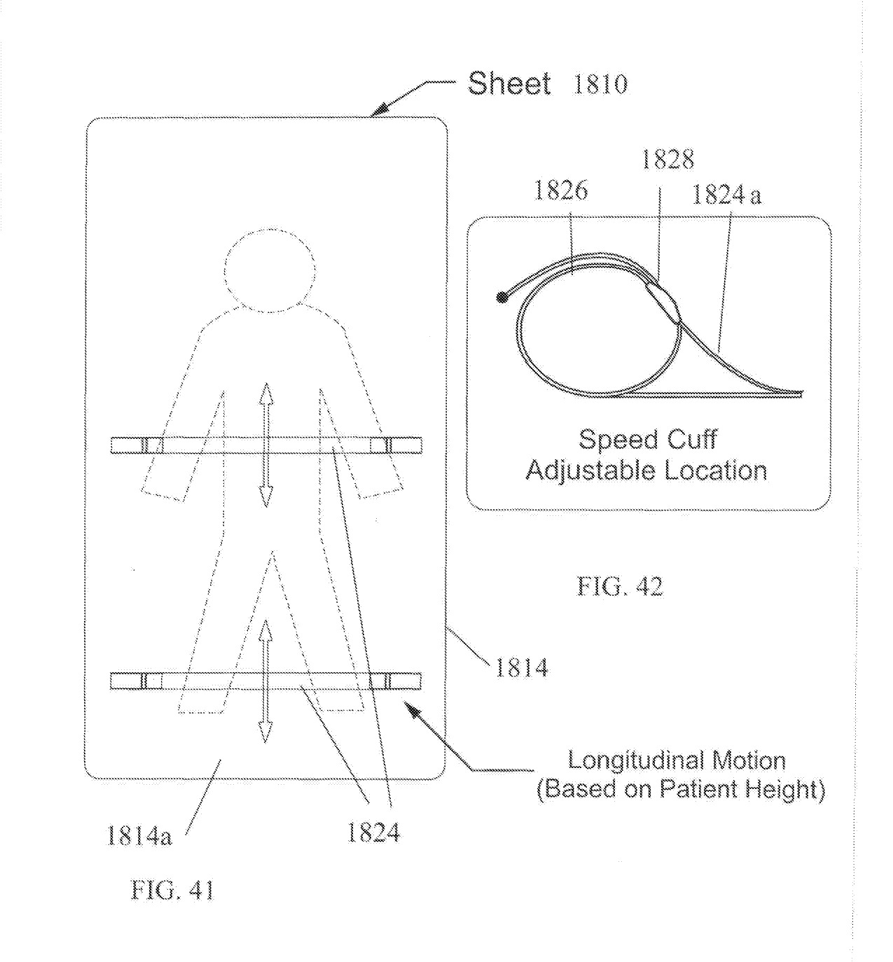

Referring to FIG. 39, as noted above, bidirectional region 1720 may be provided on only a portion of the cover, for example, the lower surface 1714a of cover 1710. For example, region 1720 may be optionally limited to the lower portion of cover 1710 so that it is located at and below the sacrum/coccyx region of the patient. For example, typically about 60 to 70% of a person's weight is concentrated in the sacrum region. Therefore, region 1720 may be located under that portion of a person where the greatest amount of weight is concentrated.

Referring to FIGS. 41 and 42, the numeral 1810 designates yet another embodiment of a cover or sheet that may be used to move a patient across a patient support surface. Cover 1810 may be constructed in a similar fashion to the covers described above and include an top panel 1812, which provides a soft surface 1812a for a patient supported thereon, and a bottom panel 1814 that includes a low friction surface 1814a. Top panel 1812 includes a pair of straps 1824, which are secured to cover 1810 to provide an optional restraint for a patient supported on cover 1810. For example, straps 1824 may comprise woven straps that are stitched or glued are welded or otherwise adhered to cover 1810.

Straps 1824 extend across the top panel but terminate before (or inward of) the outer edges of cover 1810 and include looped ends 1826, which are secured in their looped configuration by fasteners 1828, such as cam clamps or the like. The size of loops 1826 is adjustable to accommodate different patients of different sizes. And, the location of the straps may be varied to accommodate different heights and different sizes of patients, but are typically located so that one strap aligns under the chest of the patient so that the loops will align with a patient's wrists, and the other strap aligns under the feet or lower portions of the patient's legs so that the loops can be looped around a patient's ankles.

There are many instances when it may be preferable to be able to restrain a patient. For example. ICU patients are often sedated and are connected via various tubing and monitors. To protect them from inadvertently becoming disconnected from the monitor or tubing, it may in some case be helpful to restrain them. In addition patients with psychiatric episodes can be combative and dangerous to themselves or caregivers. To prevent the patient from awaking and pulling out their connections, or creating an adverse condition, a caregiver will currently often restrain the patient to the frame of the bed. This requires the use of a secondary strap to be anchored, which limits the motion the patient can be moved, both by the surface or frame itself. Further, in some conditions, performing motions such as “Gatching” the bed can cause unintended slack in the straps allowing them to potentially loosen or become removed.

Referring again to FIG. 42, strap 1824 may include a base strap that is secured to the cover and a secondary strap 1824a which is secured (for example, by stitching, welded, or gluing or the like) to the base strap to form the loop. Alternately, strap 1824 is sufficiently long so that its ends can be looped back to form the restraint loops, which ends are then secured back on the main body of the strap by a fasteners mounted to the strap inward of its ends. Thus, cover 1810 provides internal straps build into the cover to use the patient's own weight as an anchoring point to secure the patient, but still allow full range of motion of the bed frame and surface. Additionally, this design requires no secondary devices and could allow one caregiver to secure a sedated or combatant patient.

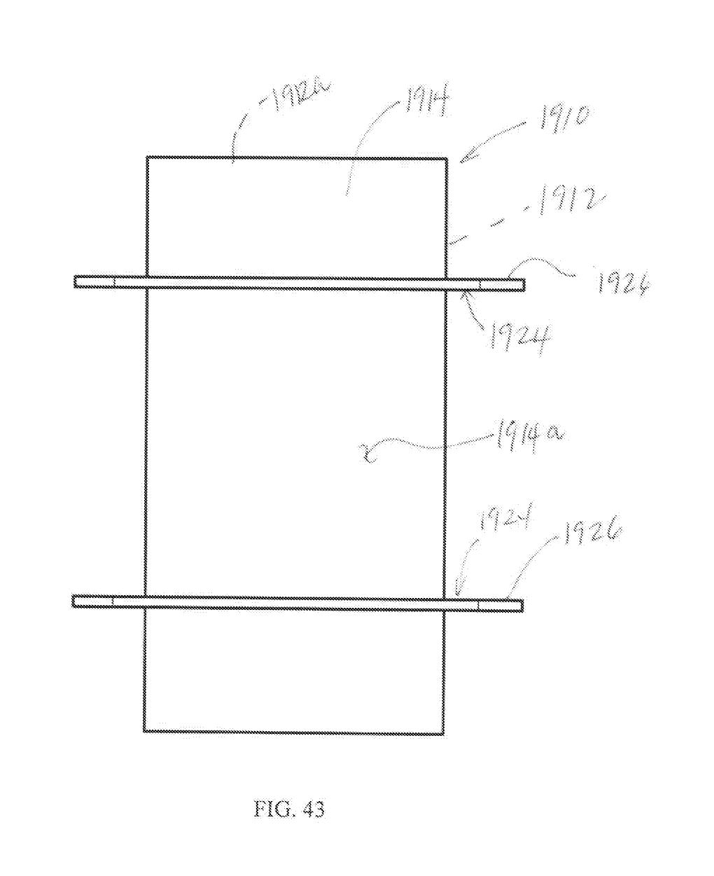

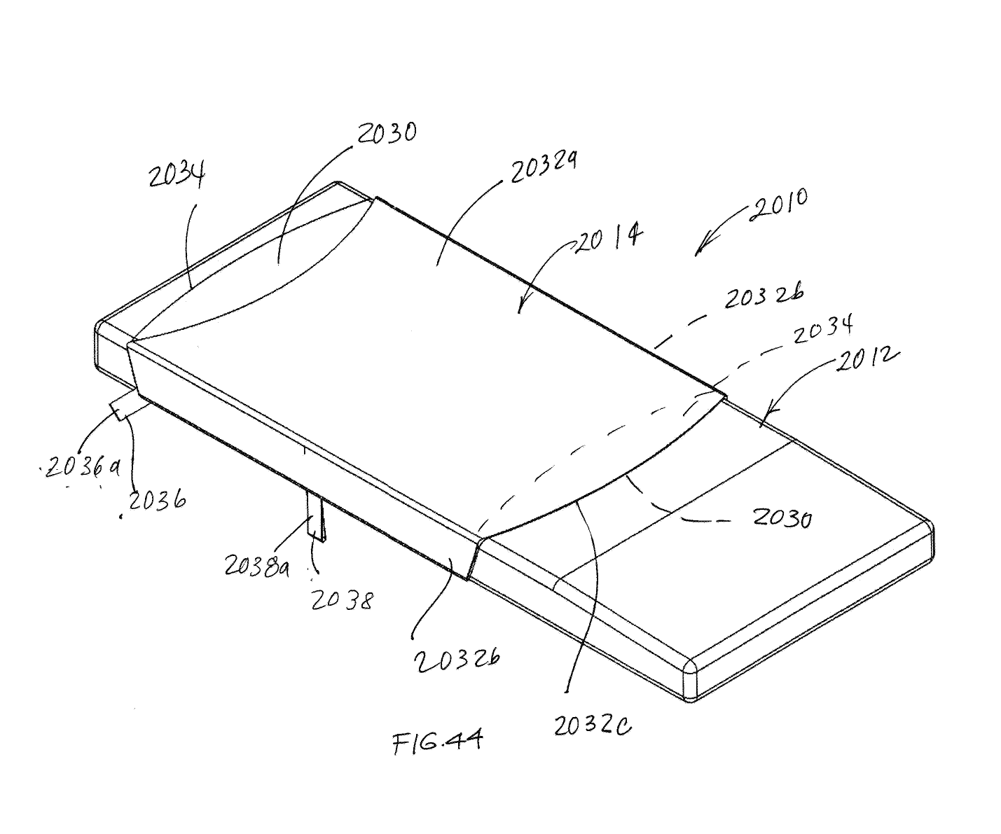

Referring to FIG. 43, the numeral 1910 designates yet another embodiment of a cover or sheet that may be used to move a patient across a patient support surface. Cover 1910 may be constructed in a similar fashion to the covers described above and include a top panel 1912, which provides a soft surface 1912a for a patient supported thereon, and a bottom panel 1914 that includes a low friction surface 1914a. Bottom panel 1914 also includes a pair of straps 1924, which are secured to bottom panel 1914 and facilitate the movement of a patient supported on cover 1910 across the patient support surface. For example, straps 1924 may comprise woven straps that are stitched or glued or welded or otherwise adhered to bottom panel 1914 of cover 1910.

Straps 1924 are sized so that they extend beyond the opposed edges of the cover and further may include looped ends 1926 spaced from the edges of cover 1910, which facilitate a caregiver's gripping of the straps. For example, the size the loops 1926 may vary but optionally may be sufficiently large enough to allow a caregiver's arms to pass through the loops to allow their hands to then engage the straight portion of the straps. This further allows a caregiver to stand adjacent the patient support surface with their backs straight and upright and with their arms at an approximate 90° angle to their body, which is considered to be their “power window”, so that they can pull on the sheet without bending.

The location of the length of the straps may be varied to accommodate different heights and different sizes of patients, but are typically located so that one strap aligns under the chest of the patient and the other strap aligns under the feet or lower portions of the patient's legs.

It is believed that the combination of the low friction surface and the accessible straps significantly improve the maneuverability of the patient and reduce the stress and strain on a caregiver's back and hands over standard sheets.

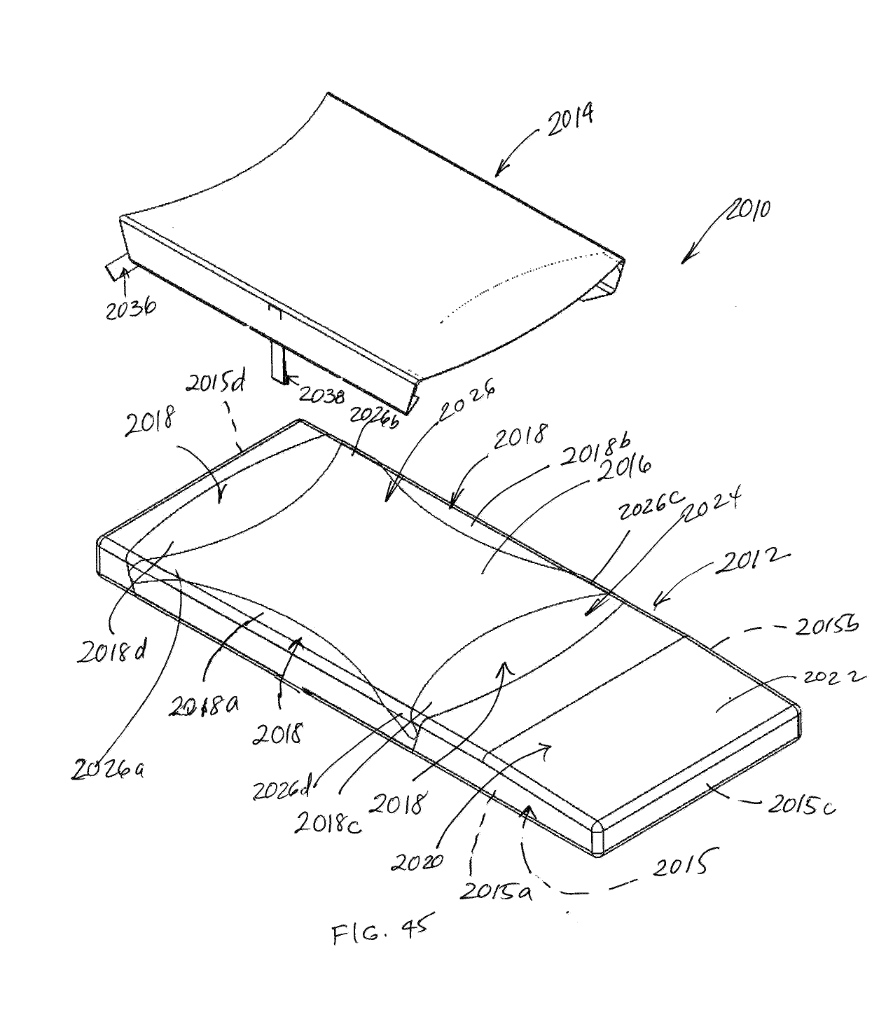

Referring to FIGS. 44-46, the numeral 2010 generally designates a cover system, which is suitable for use on a support surface, such as the mattress. For ease of description, cover system 2010 will be described in reference to a mattress 2015, such as a hospital bed mattress. As will be more fully described below, cover system 2010 includes a base sheet 2012 and a top sheet 2014, which are configured to reduce the shear on a patient supported on cover system 2010, while still providing a system that wicks away moisture and helps with its evaporation As best seen in FIG. 45, base sheet 2012 includes a region 2016 of low friction. For example, region 2016 is located under the sacrum and coccyx location of a patient, where friction between a patient and an underlying support surface is of greatest concern in regard to the development of pressure ulcers. Optionally, region 2016 is flanked by one or more regions of increased friction 2018, which limit migration of a patient, for example, off the opposed sides 2105a, 2015b or toward foot end 2015c of the underlying mattress.

In the illustrated embodiment, bottom sheet 2012 includes one or more regions of increased friction 2018a, 2018b overlying and at or adjacent the respective opposed sides 2015a, 2015b of the underlying mattress. Bottom sheet 2012 also may include a region of increased friction 2018c that aligns over at a medial portion, such as the tight section, of the underlying mattress, and, further, a region of increased friction 2018d that overlies or is near the head end of the underlying mattress. Regions of increased friction 2018a, 2018b limit the migration of a patient off either side of the mattress and, further, work in conjunction with the positioners, described above, to help keep the top sheet in position and prevent the top sheet from moving when supporting a patient in a turning position. Region of increased friction 2018c over the medial portion, such as the thigh section, of the underlying mattress limits the migration of a patient toward the foot end of the mattress. Region of increased friction 2018d is provided to limit the migration of a patient's pillow toward the head end of the underlying mattress.

Further, regions of increased friction 2018a, 2018b may help keep the positioners in place. Optionally, the positioners may include regions of high friction on their sides that face the base sheet to further assist in retaining the positioners in place when turning a patient, at least when they are lying flat on the base sheet. To that end, the regions of high friction of the positioners may be located at one end of the side that faces the base sheet so that when initially placing the positioners, the positioners may slide across the base sheet without significant resistance. When in position, the high friction regions of the positioners may cooperate with the high friction regions of the base sheet to hold the positioners in position.

For example, the region of low friction may be formed from a membrane that is applied to the panel of material that forms sheet 2012 and forms the low friction surface, such as silicone membrane, or from a layer of material that has a low coefficient of friction, such as polyester or nylon. To achieve the low coefficient of friction, the material forming the region of low friction may be chemically altered or mechanically altered, such as by calendaring, to form a smooth surface to thereby form the low coefficient of friction.

In one embodiment, the region of low friction may be formed by a region of the sheet itself, for example, from a weaved polyester or a weaved nylon, which is then laminated with a highly breathable membrane, such as a urethane membrane or an EPTFE membrane so that the sheet is impermeable to liquids, but breathable or permeable to moisture.

The regions of increased friction may be formed by a material with a high coefficient of friction or modified to have a high coefficient fiction. In one embodiment, the regions of increased friction are formed from unbroken loop material. In another embodiment, the regions of increased friction are formed by applying flock to a substrate material that forms the sheet, which would then increase the coefficient of friction of the sheet at least in one direction, for example. In this manner a directional friction may be provided.

The regions of increased friction 2018a, 2018b, 2018c, and 2018d may be formed from strips of high friction material or materials that are rendered to have a high coefficient of friction, and may be formed from panels with high coefficient of friction. Further, the regions of increased friction may be configured with increased medial portions, such as formed by concave edges, which edges are faced inwardly toward the central portion of the base sheet to thereby increase the width of the regions of increased friction. The purpose of having the increased width (such as formed by the curved edges) is twofold—first, it increases the increased friction surface contact area where needed, and secondly it also provides visual indicia or markers on how to align the top sheet relative to the bottom sheet. For example, when the curved edges of the base sheet are aligned with the curved edges of the top sheet (described below) a caregiver knows that they are properly aligned. It also helps with the look and feel of the sheet by providing a more aesthetically pleasing design

In addition, the sheet 2012 includes one or more regions 2020 of a soft material, such as a knit fabric, which is soft to the touch and provides a comfortable feel for the skin of a patient supported thereon. Furthermore, the soft material is configured to be highly breathable so that it wicks away moisture and helps evaporate moisture that may occur at sheet 2012. For example, a suitable knit fabric includes polyester or nylon or a blend of both. As more fully described below, at least the exposed regions of the soft material are located over the foot end of the underlining mattress and extend between the region of increased friction 2018c and the foot end 2015c of the underlying mattress.

In the illustrated embodiment, sheet 2012 is configured to fully extend over mattress 2015 and, further, extend down the sides and ends of the mattress so that it can be tucked under the mattress or may include elasticized portions to form a fitted sheet. Optionally, sheet 2012 may include an outer perimeter or side portions that are flexible and/or elastic so that they can expand and/or contract to allow for the sheet to be used in conjunction with a mattress that has a turning function.

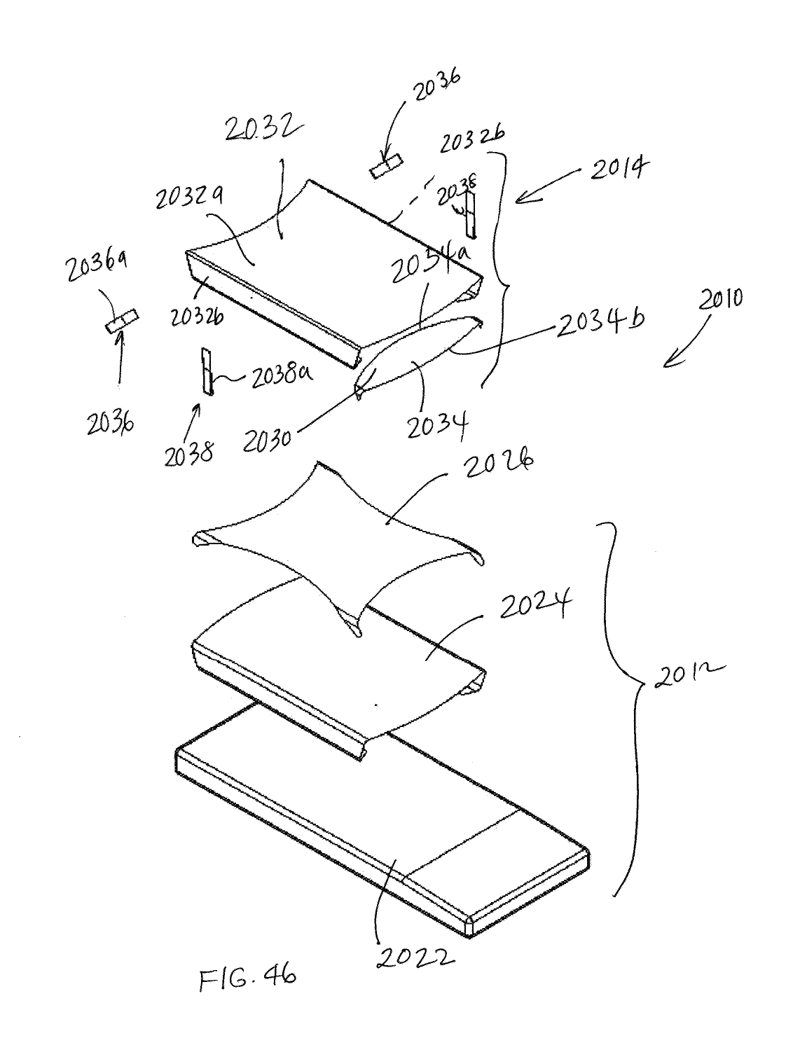

Referring to FIG. 46, base sheet 2012 may be formed from a plurality of layers. For example, base sheet 2012 may include a base layer 2022, an intermediate layer 2024, and a top layer 2026, with each of the layers joined together for example with seams, such as by stitching, welding, or a combination of stitching and sealing to form base sheet 2012. Base layer 2022 may be entirely formed from a knitted fabric, which extends from the foot end to the head end of mattress 2015, but only exposed, as noted above, between, for example, the thigh section and the foot end of mattress 2015.

Intermediate layer 2024 may provide the increased friction regions and extend from one side 2015a to the other side 2015b of mattress 2015 and extend from the head end 2015d, or adjacent the head end 2015, of the mattress to a medial portion, such as the thigh section, of mattress 2015. Top layer 2026 extends over intermediate layer 2024 and is configured to only partially cover intermediate layer 2024 to leave portions of intermediate layer 2024 exposed to thereby form the regions of increased friction 2018a, 2018b, 2018c, and 2018d. For example, the foot end edge, the opposed side edges, and head end edge of top layer 2026 may be convex, with the corners 2026a, 2026b, 2026c, and 2026d extending to the four corners of the intermediate layer, which wrap over the edges of the opposed side 2015a, 2015b of mattress 2015.

As noted above, top sheet 2014 is configured to cooperate with a sheet 2012 to reduce friction there between over at least a portion thereof so as to facilitate movement of a patient supported on system 2010 to minimize shear and/or help with repositioning. In one embodiment, top sheet 2014 is sized so that extends only over a portion of base sheet 2012 to prevent accumulation of excess material, which tends to form folds or wrinkles, which can create stress points on a patient's skin. Top sheet 2104 may also be also made out of a knitted fabric that is soft to the touch and provides a comfortable feel for the patient's skin. The fabric forming sheet 2014 may also be configured to wick away moisture and help with its evaporation. In one embodiment, sheet 2014 is formed from a liquid impermeable, moisture permeable fabric, such as a lamination of layers including an EPTFE membrane or a urethane layer as part of the construction. Also as part of the lamination a weaved layer may be added to add rigidity to the system and help reposition the patient.

The underside or bottom surface of top sheet 2014 of the top sheet is at least partially and, optionally, mainly a low friction surface. For example, sheet 2014 may include a slippery layer, which is formed from a weaved polyester or a weaved nylon, which is then laminated with a highly breathable membrane, such as a urethane membrane or an EPTFE membrane so that the sheet is impermeable to liquids, but breathable and/or permeable to moisture.

Top sheet 2014 may be formed from similar materials to base sheet 2012 or different materials. In this manner, both the low friction or slippery surfaces (of the top sheet and bottom sheet which face each other) can work together to form a frictionless or near frictionless zone, which helps minimize shear on the patient's skin and, especially, for example the coccyx and sacrum regions, while helping with moving or boosting a patient.

Optionally, top sheet 2014 may also include one or more regions of increased friction. For example, the underside or bottom side of top sheet 2014 may have a region of increased friction 2030 at or near the thigh section. The thigh section region 2030 creates a zone of high friction under the leg of the patient, thereby using the weight of the patient's leg to prevent migration, while not restraining any movement at the sacrum and coccyx regions of the patient. The region of increased friction may be formed by a material with a high coefficient of friction or modified to have a high coefficient fiction. In one embodiment, the regions of increased friction are formed from unbroken loop material or flock, as an example. In another embodiment, the regions of increased friction are formed by applying flock to a substrate material, which would then increase the coefficient of friction of the material at least in one direction, for example. In this manner a directional friction may be provided.

Similarly, the head end of sheet 2014 may include a region of increased friction 2030 that overlies the head end or abuts the head end of sheet 2014 to reduce or limit the migration of a patient's pillow toward the head end of mattress 2015. Region of increased friction 2030 at the thigh section may work in conjunction with the corresponding region of increased friction 2018c on the bottom sheet 2012 to create a high level of friction between the two sheets and then limit undesired movement.

Referring again to FIG. 46, sheet 2014 includes a base panel 2032 and one or more auxiliary panels 2034, which are joined with base panel 232 at the head end of sheet 2014, for example by stitching, to provide the regions of increased friction 2030. In the illustrated embodiment, each panel 2034 includes non-linear edges 2034a and 2034b, such as arcuate edges, with edge 2034a of head end panel being located at the head end of mattress 2015 and edge 2034b abutting or overlaying the head end edge of base panel 2032. The panel forming thigh section region 2030 underlies the foot end of sheet 2014 so it can cooperate with region 2018c.

Optionally, top sheet 2014 may also include one or more handles 2036, 2038 (FIGS. 45 and 46) to help a caregiver with turning, boosting and transferring a patient by moving a patient supported on top sheet 2014 relative to base sheet 2012. Handles 2036 and 2038 may be formed from straps 2036a and 2036a, which are secured to top sheet 2014, for example by stitching. The straps may be varied in length to help prevent excess of bending by a caregiver when reaching over a patient on the other side to turn them. Optionally, each strap 2036a may be angled, i.e., angled at a non-orthogonal angle to the longitudinal axis of sheet 2014. By angling strap 2036, a caregiver can simply pull on strap 2036a to effect sliding movement the patient toward the head end, rather than having to lift and twist of the strap as is the case with straps that are orthogonal to the longitudinal axis of the sheet.

In yet a further aspect, the top sheet includes a central portion 2032a for aligning over the sheet 2012 and mattress 2015 and two downwardly depending portions 2032b that extend from the central portion 2032a for extending downwardly along the sides of the mattress. Optionally, the downwardly depending portions include the one or more handles.

In addition, optionally, the back side of the strap or straps may include a friction surface, such as a height friction fabric or layer, such as flocking, to thereby help to keep the straps in position and also help to keep the top sheet in the desired position.

As noted above, top sheet 2014 may be shorter than base sheet—e.g. sheet 2014 includes a foot end terminal edge 2032c, which is spaced from the foot end of mattress. A short top sheet strikes a balance between having enough support to move the patient, while not being too big, which could then create folds and/or wrinkles, which could create stress points for some patient's skin. The shorter length also helps nurses to remove those folds and/or wrinkles.

Further, because of the partial overlapping nature of the two sheets and the various seams and/or transitions between the low friction and high friction regions, or other design elements such as graphic designs, the design elements of the top and bottom sheet can be used show when it is aligned (as noted above) and when it is out of alignment. Therefore, the various seams and/or transitions between the low friction and high friction regions may provide guidance to caregiver on when to reposition the patient and where to reposition the patient. In one embodiment, the flexible nature of the two sheets allows the sheets to work together to promote envelopment as well as shear management and microclimate management of the underlying support surface to reach the patient.

In any of the above cover components, an antimicrobial treatment or component may be provided. For example, antimicrobial materials, such as copper or silver or the like, may be provided in the form of a coating or suspended in the materials forming the respective components. Further, in any of the above covers a sensor may be provided to indicate a number of different conditions: (1) moisture; (2) patient movement and/or egress; (3) temperature and other relevant patient data.

In each of the above covers or base sheets, the cover may be configured as a bed sheet, including a fitted or flat bed sheet. Further, the covers or top sheets may be used with or without overlying pads.

It should be understood that alterations and changes can be made without departing from the spirit and broader aspects of the invention as defined in the appended claims, which are to be interpreted in accordance with the principles of patent law including the doctrine of equivalents. For example, one feature in one embodiment may be combined with other features or be substituted with other features in another embodiment.

This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

We claim:

1. A cover system comprises:
a base sheet, the base sheet being adapted to cover an underlying mattress; and
a top sheet configured to wick away moisture and to cooperate with the base sheet to reduce shear on a patient supported on the cover system.

2. The cover system according to claim 1, at least a portion of the top surface of the base sheet includes a low friction region.

3. The cover system according to claim 2, wherein at least a portion of the bottom surface of the top sheet includes a low friction region.

4. The cover sheet system according to claim 3, wherein the low friction region of the top sheet at least generally aligns with the low friction region of the base sheet to reduce the friction between the top sheet and the base sheet and thereby reduce shear on a patient supported on the cover sheet system.

5. The cover sheet system according to claim 3, wherein the top surface of the base sheet includes one or more regions of increased friction over or adjacent to the low friction region of the base sheet to limit undesirable movement.

6. The cover sheet system according to claim 3, wherein the top surface of the base sheet includes one or more regions of increased friction over the low friction region of the base sheet for aligning with a head end of the underlying mattress.

7. The cover sheet system according to claim 3, wherein the top surface of the base sheet includes one or more regions of increased friction over the low friction region of the base sheet for aligning with the opposed outer edges of the underlying mattress to limit migration of a patient supported on the cover sheet system off the side of the underlying mattress.

8. The cover sheet system according to claim 2, the top surface of the base sheet includes a region of increased friction over or adjacent to the low friction region at a medial portion of the base sheet.

9. The cover sheet system according to claim 8, wherein the region of increased friction is oriented for extending transversely across the underlying mattress to limit the migration of a patient toward the foot end of the underlying mattress.

10. The cover sheet system according to claim 3, wherein the bottom surface of the top sheet includes a region of increased friction over or adjacent to the low friction region of the top sheet.

11. The cover sheet system according to claim 10, wherein the region of increased friction of the top sheet is located at a thigh section of the top sheet.

12. A cover system comprises:
a base sheet, the base sheet being adapted to cover an underlying mattress; and
a top sheet configured to wick away moisture and to cooperate with the base sheet to reduce shear on a patient supported on the cover system, the top sheet including a central portion for aligning over the underlying mattress and two downwardly depending portions that extend from the central portion for extending along the sides of the mattress.

13. The cover sheet system according to claim 12, wherein one or more downwardly depending portions include one or more handles.

14. The cover sheet system according to claim 12, wherein the top surface of the base sheet includes one or more low friction regions and one or more regions of increased friction over the low friction region to limit undesirable movement.

15. The cover sheet system according to claim 14, wherein at least a portion of the bottom surface of the top sheet includes a low friction region and a region of increased friction over or adjacent to the low friction region of the top sheet.

16. The cover sheet system according to claim 12, wherein the handles comprise straps.

17. The cover sheet system according to claim 16, the top sheet including a longitudinal axis wherein at least one of the straps is an angled strap angled with respect to the longitudinal axis of the top sheet.

18. The cover sheet system according to claim 16, wherein the angled strap extend toward the head-end of the top sheet.

19. The cover sheet system according to claim 13, wherein the one or more handles have a high friction surface for facing the base sheet.

20. The cover sheet system according to claim 12, wherein the top sheet and/or the bottom sheet are highly breathable thereby allowing for moisture transmission through the respective sheet.

21. The cover sheet system according to claim 12, wherein the top sheet and/or the bottom sheet is configured to prevent transmission there through of fluid, viruses and/or bacteria.

22. The cover sheet system according to claim 12, wherein the top sheet and/or the bottom sheet is fluid impermeable.

23. The cover sheet system according to claim 13, wherein the handles are configured for boosting and turning a patient.
